(19) United States
(12) Patent Application Publication
(10) Pub. No.: US 2019/0228039 A1
(43) Pub. Date: Jul. 25, 2019

(54) SYSTEM AND METHOD FOR PROVIDING FOOD-RELATED INFORMATION

(71) Applicant: Everything Food, Inc., Orange, CA (US)

(72) Inventors: Daniel Edwin Doble, Irvine, CA (US); Peter B. Balsells, Orange, CA (US)

(21) Appl. No.: 16/250,935

(22) Filed: Jan. 17, 2019

Related U.S. Application Data
(60) Provisional application No. 62/620,358, filed on Jan. 22, 2018.
(60) Provisional application No. 62/640,480, filed on Mar. 8, 2018.

(51) Int. Cl. G06F 16/903; G06F 16/22; G06F 16/28

(52) U.S. Cl. CPC G06F 16/90344; G06F 16/285; G06F 16/2282

(57) ABSTRACT

A system and method of providing food-related information is provided. The method includes receiving a user-generated food-related query and generating, in response to the query, a subject identifier indicative of a food-related subject of the query. The method further includes accessing at least one computer database with a plurality of tables. Each table has a top-level record corresponding to the subject of the table and a plurality of lower-level records that correspond to members of the subject of the table. Each lower-level record of the plurality of lower-level records comprises a first identifier indicative of the lower-level record, at least one second identifier corresponding to the first identifier of another record in the table, and a third identifier corresponding to the top-level record of the table. The method further includes transmitting to the user multiple tables that include a primary table with lower-level records having third identifiers that correspond to the subject identifier.

### CLAIM OF PRIORITY

The present application claims the benefit of priority to U.S. Provisional Appl. No. 62/620,358 filed Jan. 22, 2018 and U.S. Provisional Appl. No. 62/640,480 filed Mar. 8, 2018, each of which is incorporated in its entirety by reference herein.

### BACKGROUND

### Field

This application relates generally to systems, methods, and databases for providing food-related information to a plurality of users that facilitate creation and modification of recipes.

### Description of the Related Art

In conventional computer-based systems or databases, recipes are built to be stand-alone entities or a given recipe may sometimes be incorporated into a subsequent recipe. For example, to make a pie, the pie crust may be called out from a previous chapter of a cookbook in the pie recipe (e.g., the cookbook may say to use “Basic Pie Crust” from another page of the cookbook). Also, recipe websites generally do not reference other recipes, unless they are from the same author, but this is not very common. Most recipe websites are ad-based, so the author does not have an incentive to post all their recipes or to link them together. They also have no incentive to reference other chef's recipes as a sub-component of their recipe.

This stand-alone approach means that the author of the recipe creates one-off recipes with non-standard techniques. The techniques are all explained in different manners, making it extremely difficult to standardize. If it is not standardized, then each recipe has to be learned individually as well. This is a challenge for both human and robots. It can take years of experience to gain proficiency to wade through the multitude of non-standard techniques.

### SUMMARY

In certain embodiments, a method of providing food-related information is provided. The method comprises receiving a user-generated food-related query. The method further comprises generating, in response to the query, a subject identifier indicative of a food-related subject of the query. The method further comprises accessing at least one computer database comprising a plurality of tables. Each table of the plurality of tables has a food-related subject. Each table of the plurality of tables comprises a top-level record corresponding to the subject of the table and a plurality of lower-level records that correspond to members of the subject of the table and that are hierarchically organized within the table. Each lower-level record of the plurality of lower-level records comprises a first identifier indicative of the lower-level record, at least one second identifier corresponding to the first identifier of another record in the table, and a third identifier corresponding to the top-level record of the table. The method further comprises transmitting multiple tables of the plurality of tables to the user. The multiple tables comprise a primary table and at least one other table. The primary table comprises lower-level records having third identifiers that correspond to the subject identifier.

In certain embodiments, a computer system for providing food-related information, is provided. The system comprises at least one processor and at least one memory device in operative communication with the at least one processor. The at least one processor is configured to provide food-related information to a plurality of user computing devices in response to food-related queries received from the plurality of user computing devices. The at least one processor is configured to respond to a food-related query by generating a subject identifier indicative of a food-related subject of the query. The at least one memory device is operative to store at least one computer database comprising a plurality of tables. Each table of the plurality of tables has a food-related subject. Each table of the plurality of tables comprises a top-level record corresponding to the subject of the table and a plurality of lower-level records that correspond to members of the subject of the table and that are hierarchically organized within the table. Each lower-level record of the plurality of lower-level records comprises a first identifier indicative of the lower-level record, at least one second identifier corresponding to the first identifier of another record in the table, and a third identifier corresponding to the top-level record of the table. The at least one processor is further configured to access the at least one computer database stored by the at least one memory device and to transmit multiple tables of the plurality of tables to the user. The multiple tables comprise a primary table and at least one other table. The primary table comprises lower-level records having third identifiers that correspond to the subject identifier.

In certain embodiments, a non-transitory computer storage is provided which has stored thereon a computer program that instructs a computer system to provide food-related information. The food-related information is provided by at least receiving a user-generated food-related query, generating, in response to the query, a subject identifier indicative of a food-related subject of the query, accessing at least one computer database comprising a plurality of tables, and transmitting multiple tables of the plurality of tables to the user. Each table of the plurality of tables of the at least one computer database has a food-related subject and comprises a top-level record corresponding to the subject of the table and a plurality of lower-level records that correspond to members of the subject of the table and that are hierarchically organized within the table. Each lower-level record of the plurality of lower-level records comprises a first identifier indicative of the lower-level record, at least one second identifier corresponding to the first identifier of another record in the table, and a third identifier corresponding to the top-level record of the table. The multiple tables transmitted to the user comprise a primary table and at least one other table. The primary table comprises lower-level records having third identifiers that correspond to the subject identifier.

### BRIEF DESCRIPTION OF THE DRAWINGS

FIG. 1 schematically illustrates an example computer system for providing food-related information to a user computing device in accordance with certain embodiments described herein.

FIG. 2 is a flow diagram of an example method for providing food-related information in accordance with certain embodiments described herein.

FIG. 3 schematically illustrates a segment of an example table in accordance with certain embodiments described herein.

FIG. 4A is a flow diagram of an example method for generating the subject identifier in accordance with certain embodiments described herein.

FIG. 4B is a flow diagram of an example search in accordance with certain embodiments described herein.

FIG. 5A schematically illustrates an example list of templates in accordance with certain embodiments described herein.

FIG. 5B schematically illustrates a portion of a list of other tables in accordance with certain embodiments described herein.

FIG. 6A schematically illustrates the relationship between states and actions for a general node-to-node segment in accordance with certain embodiments described herein.

FIG. 6B schematically illustrates an example node-to-node segment for a food and recipe network in accordance with certain embodiments described herein.

FIG. 7 schematically illustrates example multiple database tables and their relationships (e.g., associations) relative to one another that facilitates the node-to-node structure in accordance with certain embodiments described herein.

FIG. 8A schematically illustrates an example segment in which the nodes are connected by a single overall action/technique in accordance with certain embodiments described herein.

FIG. 8B schematically illustrates an example segment in which the nodes are connected by two or more separate, distinct actions/techniques in accordance with certain embodiments described herein.

FIGS. 9A-9D schematically illustrate example segments in accordance with certain embodiments described herein.

FIG. 10 schematically illustrates an example set of database tables in accordance with certain embodiments described herein.

FIG. 11A schematically illustrates an example convergent connection in accordance with certain embodiments described herein.

FIG. 11B schematically illustrates an example divergent connection in accordance with certain embodiments described herein.

FIG. 12 schematically illustrates a basic recipe node-to-node network (e.g., instance) in accordance with certain embodiments described herein.

FIG. 13A schematically illustrates a convergent node-to-node network in accordance with certain embodiments described herein.

FIG. 13B schematically illustrates a divergent node-to-node network in accordance with certain embodiments described herein.

FIG. 14 schematically illustrates an example set of database tables in accordance with certain embodiments described herein.

FIG. 15A schematically illustrates an example ingredient network (e.g., for Apple) having a V-network divergent structure in accordance with certain embodiments described herein.

FIG. 15B schematically illustrates an example divergent temperature change network (e.g., for Steak) in accordance with certain embodiments described herein.

FIG. 15C schematically illustrates an example food item recipe convergent network in accordance with certain embodiments described herein.

FIG. 16A schematically illustrates an example recipe network having an A-network convergent structure in accordance with certain embodiments described herein.

FIG. 16B schematically illustrates an example convergent network in which three courses form a meal in accordance with certain embodiments described herein.

FIGS. 17A-17H schematically illustrate various examples of state change node-to-node structures in accordance with certain embodiments described herein.

FIGS. 18A-18D schematically illustrate various examples of convergent node-to-node structures in accordance with certain embodiments described herein.

FIGS. 19A-19C schematically illustrate various examples of divergent node-to-node structures in accordance with certain embodiments described herein.

FIG. 20 schematically illustrates an example set of database tables that can plot recipes onto a calendar in accordance with certain embodiments described herein.

FIG. 21 schematically illustrates an example high level network in accordance with certain embodiments described herein.

FIG. 22A-22C schematically illustrate the use of the node-to-node structure to model the cycle of life networks and its related seasonality in accordance with certain embodiments described herein.

FIG. 23 schematically illustrates an example node-to-node structure with forms that can be derived from a loaf of bread in accordance with certain embodiments described herein.

FIG. 24 schematically illustrates the node-to-node structure for whiskey in accordance with certain embodiments described herein.

FIG. 25 schematically illustrates a node-to-node structure for the process industry of fermenting wine in accordance with certain embodiments described herein.

FIG. 26A schematically illustrates an example node-to-node structure for blackberry juice in accordance with certain embodiments described herein.

FIG. 26B schematically illustrates an example nod-to-node structure for chopped peeled onions in accordance with certain embodiments described herein.

FIG. 27A schematically illustrates another example for a fresh fish cuts network in accordance with certain embodiments described herein.

FIGS. 27B-27C schematically illustrate another example for a fresh meat cut network in accordance with certain embodiments described herein.

FIG. 27D schematically illustrate another example for a cold-pressed olive oil network in accordance with certain embodiments described herein.

FIG. 28 schematically illustrates the example for chopped garlic in accordance with certain embodiments described herein.

FIG. 29A schematically illustrates an example node-to-node network for Wheat in accordance with certain embodiments described herein.

FIG. 29B schematically illustrates an example node-to-node structure for a series of traditional French Sauces in accordance with certain embodiments described herein.

FIG. 30A schematically illustrates an example node pair for halving a fresh apple in accordance with certain embodiments described herein.

FIGS. 30B-30C schematically illustrate example node pairs for halving a fresh apple, with equipment variation from that of FIG. 30A, in accordance with certain embodiments described herein.

FIG. 30D schematically illustrates an example node pair for halving a fruit, with ingredient variation from that of FIG. 30A, in accordance with certain embodiments described herein.

FIG. 31 schematically illustrates an example node-to-node V-network for a Fresh Apple in accordance with certain embodiments described herein.

FIG. 32 schematically illustrates an example node-to-node network (e.g., A-network) for orange juice in accordance with certain embodiments described herein.

FIG. 33 schematically illustrates some example multi-layer endorsed subscriptions in accordance with certain embodiments described herein.

### DETAILED DESCRIPTION

Certain embodiments described herein provide a computer-based system, method, and database (e.g., relational database) of food-related information configured to advantageously allow a user to leverage standardization to facilitate an enormous number of recipes and food-related information (e.g., ingredients, techniques, and equipment). In certain embodiments, the food-related information is organized in a node-to-node system comprising multiple food and recipe node-to-node networks. By way of analogy, the food and recipe node-to-node networks can be considered as the equivalent of standardized, interchangeable parts which facilitated the industrial revolution by avoiding the problem of individual craftsmanship as a hindrance to scaling up of industrial processes. While conventional recipe systems can be considered to be submitted by individual craftsmen and to not have interchangeable parts, in certain embodiments described herein, the node-to-node system and its food and recipe node-to-node networks provide a system utilizing “interchangeable” parts via ingredients, techniques, and equipment, and advantageously create an enormously efficient platform to enable interchangeable parts.

Certain embodiments described herein provide a computer-based system, method, and database (e.g., relational database) of food-related information configured to advantageously provide users with food-related information in a manner that facilitates the user creating recipes, making modifications to recipes, and evaluating the results of these recipes and/or modifications. For example, in certain embodiments described herein, the computer-based system is configured to quickly evaluate the user's initial request for information relevant to a recipe and its possible modifications, to determine the subject of the user's request, and to utilize a computer-based database that is structured such that the food-related information transmitted to the user includes sufficient information to allow the user to create recipes, make recipe modifications, and/or other desired operations without requiring that additional requests for additional information be transmitted to the computer-based system and database and without requiring that additional responses be processed by the computer-bases system and database. In certain embodiments, the food-related information transmitted to the user include an entire table (e.g., branch) of records corresponding to the subject of the user's request and a plurality of other entire tables (e.g., branches) of records corresponding to other subjects which correspond to potential modifications and/or other operations that the user may be expected to make. By transmitting these many tables, all in response to the initial request, certain such embodiments leverage fast transmission speeds and high bandwidths to advantageously avoid or reduce the number of subsequent information requests (e.g., dynamic, on-the-fly calls) sent by user devices to the computer-based system and database that would be needed in conventional systems in which each user modification and/or operation results in another information request send by the user device to the computer-based system and database. Certain such embodiments advantageously reduce the probability of excessive delays in receiving the information, potential crashes of the computer-based system and database, or other bottleneck-related performance degradations of the computer-based system.

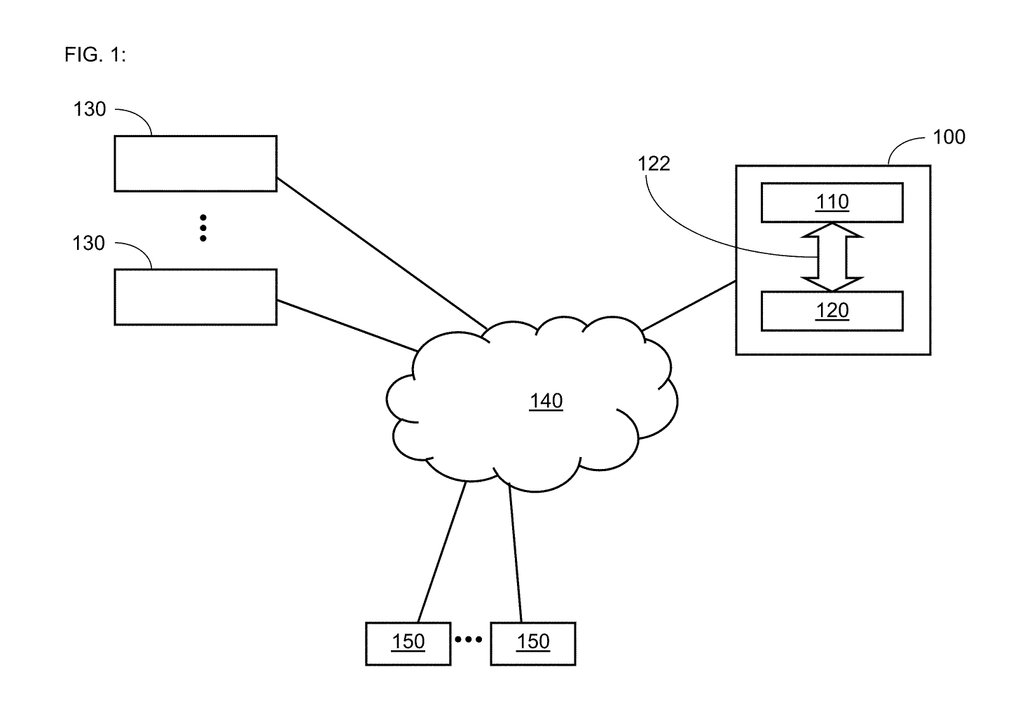

FIG. 1 schematically illustrates an example computer system 100 for providing food-related information to a user computing device 150 in accordance with certain embodiments described herein. In certain embodiments, the computer system 100 comprises at least one processor 110 (e.g., server computer) and at least one memory device 120 (e.g., server computer data storage device; tangible storage; non-transitory storage; flash memory; hard-disk drive; non-volatile storage) that is in operative communication with the at least one processor 110. The at least one processor 110 is configured to provide food-related information 122 to a plurality of user computing devices 150 in response to food-related queries received from the plurality of user computing devices 150. The at least one memory device 120 is operative to store information (e.g., instructions; data; database) to be used by the at least one processor 110 and/or generated by the at least one processor 110, and to provide the stored information to the at least one processor 110. For example, the at least one memory device 120 can store food-related information 122 that is to be retrieved by the at least one processor 110 and provided to the user computing devices 150 (e.g., in response to queries received by the at least one processor 110 from the user computing devices 150).

In certain embodiments, the at least one processor 110 is in operative communication with one or more operator computing devices 130 (e.g., personal computers) via the internet 140. In certain embodiments, the one or more operator computing devices 130 are configured to provide operator input (e.g., commands; data) from one or more system operators (e.g., system administrators) to the at least one processor 110, to receive system output (e.g., data regarding system operations, analytics, and/or diagnostics) from the at least one processor 110, and to provide information (e.g., based on the system output) to the one or more system operators. The one or more operator computing devices 130 are configured to control and/or modify operation of the at least one processor 110 and/or create and/or modify the food-related information 122 stored by the at least one memory device 120. For example, the at least one processor 110 can communicate with an operator computing device 130 via the internet 140 so that a system operator using the operator computing device 130 can set up, access, diagnose, monitor, modify, and/or otherwise control the operation of the at least one processor 110.

In certain embodiments, the at least one processor 110 is in operative communication with one or more user computing devices 150 (e.g., smartphones; smart tablets; personal computers) via the internet 140. The one or more user computing devices 150 are configured to provide user input (e.g., queries; commands; data) from one or more users (e.g., resources; chefs; individuals) to the at least one processor 110, to receive food-related information 122 from the at least one processor 110, and to provide the food-related information 122 to the one or more users. For example, the at least one processor 110 can communicate with a user computing device 150 via the internet 140 so that a user using the user computing device 150 can transmit a query to the at least one processor 110 (e.g., via a user's account which is specified by a username and protected by a password) and the at least one processor 110 can receive the query. For another example, the at least one processor 110 can communicate with the user computing device 150 via the internet 140 so that the at least one processor 110 transmits food-related information 122 to the user computing device 150 (e.g., in response to the query). For still another example, the at least one processor 110 can communicate with the user computing device 150 via the internet 140 so that the user can set up, modify, and/or otherwise use the user's account to request and receive food-related information 112 from the at least one processor 110.

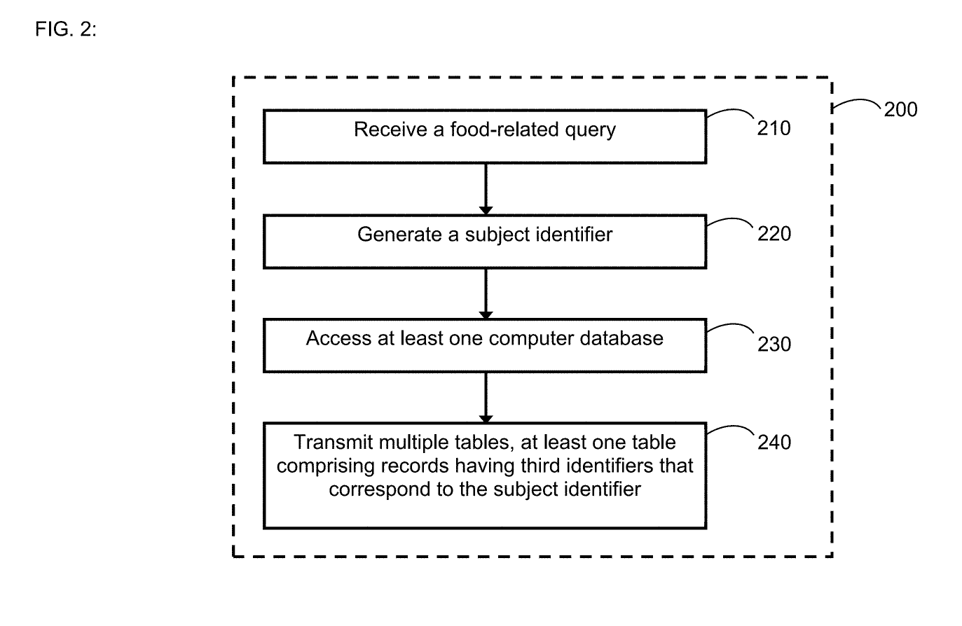

FIG. 2 is a flow diagram of an example method 200 (e.g., performed by the example computer system 100) for providing food-related information (e.g., to a user computing device 150) in accordance with certain embodiments described herein. In certain embodiments, a software application is running on the user computing device 150, the software application configured to receive the food-related information transmitted from the computer system 100 to the user computing device 150 and to present the received food-related information to the user. In an operational block 210, the method 200 comprises receiving a food-related query (e.g., a user-generated food-related query from one of the plurality of user computing devices 150). In an operational block 220, the method 200 further comprises generating, in response to the query, a subject identifier indicative of a food-related subject of the query. In an operational block 230, the method 200 further comprises accessing at least one computer database comprising, inter alia, a plurality of tables (e.g., branches)(e.g., stored by the at least one memory device 120 of the computer system 100). In an operational block 240, the method 200 further comprises transmitting (e.g., from the computer system 100 to the user computing device 150 via the internet 140) multiple tables of the plurality of tables to the user (e.g., to the user computing device 150), the multiple tables comprising a primary table and at least one other table. The primary table comprises lower-level records having third identifiers that correspond to the subject identifier.

In certain embodiments, each table (e.g., branch) of the plurality of tables has a food-related subject. Examples of types of food-related subjects of a table include but are not limited to: a food class; a food preparation technique; a food preparation tool; a food brand; a food manufacturer; a food provider. Each table of the plurality of tables comprises a top-level record corresponding to the subject of the table and a plurality of lower-level records that correspond to members of the subject of the table and that are hierarchically organized within the table. Each lower-level record of the plurality of lower-level records comprises a first identifier indicative of the lower-level record, at least one second identifier corresponding to the first identifier of another record in the table, and a third identifier corresponding to the top-level record of the table.

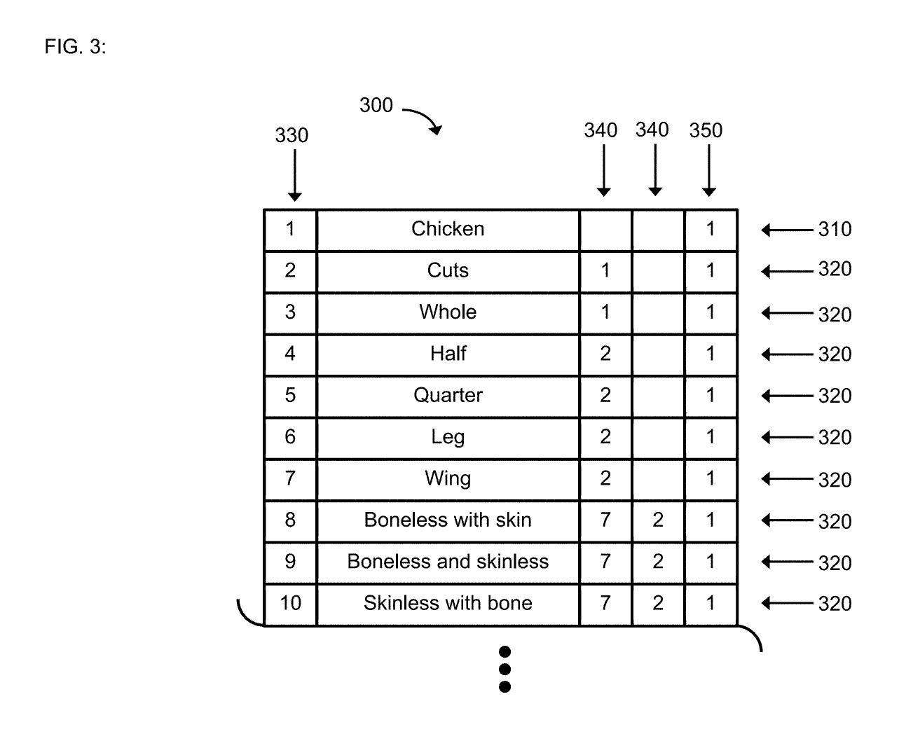

FIG. 3 schematically illustrates a segment of an example table 300 in accordance with certain embodiments described herein. The example table 300 can be a portion of a larger table of the computer-based database. The example table 300 has a food-related subject (e.g., food class “chicken”) and the table 300 comprises a top-level record 310 corresponding to the subject of the table 300. The example table 300 further comprises a plurality of lower-level records 320 that correspond to members of the subject of the table 300 and that are hierarchically organized within the table 300. These members can include derivative forms of the subject of the table 300 (e.g., different cuts; different seasonings; forms resulting from different preparation or processing techniques).

For example, the lower-level records 320 of the table 300 of FIG. 3 include records corresponding to various derivative forms of chicken (e.g., cuts; whole; half; quarter; leg; wing; boneless with skin; boneless and skinless; skinless with bone). Each lower-level record 320 comprises a first identifier 330 (e.g., primary key; alphanumeric identifier) indicative of the lower-level record 320, and at least one second identifier 340 (e.g., a foreign key; alphanumeric identifier) corresponding to the first identifier 330 of another record in the table 300. The second identifier 340 points (e.g., provides a link) to a higher-level record (e.g., a record from which the lower-level record 320 can be obtained). In conventional relational database structures with only first identifiers and second identifiers (e.g., only primary keys and foreign keys of a unique numeric indexing system), to navigate through the table 300 from a deep, lower-level record 320 to the top-level record 310 would require using the first and second identifiers to make multiple jumps amongst multiple lower-level records 320. For example, in a conventional relational database structure for aftermarket automobile parts, it may be desirable to identify a particular part (e.g., with a corresponding part number) and determine which automobile sub-assembly (e.g., body; engine; interior; exhaust system) is related to the part. In the conventional relational database structure, a database query would return only the first parent foreign key, which would point to the next most outer assembly (e.g., “engine mounting system,” “rear seat”) and the user would have to follow a series (e.g., 2, 3, or more) of parent level foreign keys (e.g., “stair-stepping” from a lower-level record to the next-higher-level record) before arriving at the top-level (e.g., “Interior Systems”).

In certain embodiments, each lower-level record 320 further comprises a third identifier 350 (e.g., a sliding key or toplevelID; alphanumeric identifier) corresponding (e.g., pointing; providing a link) to the top-level record 310 of the table 300. In contrast to the second identifiers 340 which only point to other lower-level records 320, the third identifier 350 of each lower-level record 320 points (e.g., provides a link) to the top-level record 310 of the table 300. For example, as shown in FIG. 3, each lower-level record 320 has a third identifier 350 that identifies the subject of the table 300 (“chicken”) for the lower-level record 320, regardless of the location of the lower-level record 320 within the table 300.

In certain embodiments, the third identifier 350 can be used to identify lower-level records 320 that correspond to members of the subject of the user's query (e.g., the third identifier 350 matches the subject identifier from the user's query) so that these lower-level records 320 are among those transmitted to the user. For example, if the subject identifier from the user's query corresponds to “broccoli” (e.g., the user seeks to develop recipes using broccoli), by transmitting a primary table including all the lower-level records 320 that have a third identifier 350 that matches the subject identifier for “broccoli,” the records of the transmitted primary table will include all the various derivative forms of “broccoli” (e.g., chopped; spears; whole) that the user may be expected to use. Without the third identifier 350 (e.g., sliding key), traditional relational database structures have been burdened with a “many-to-many” design concept in which the foods (e.g., cucumber; apple; watermelon) were stored in an isolated table, and the possible “forms” or form definitions (e.g., sliced; chopped) were stored in another isolated table, and the intersection or relationships between the two tables (e.g., cucumber slices; chopped apple; etc.) were stored in yet another table, with multiple foreign keys. This structure would utilize an element-by-element maintenance which creates a burden on the database, the hardware, and the administrative staff managing the system. In addition, the absence of the third identifier 350 would require “stair-stepping” from a lower-level record to a top-level record to determine which food the lower-level record refers to (e.g., cucumbers; apples).

The third identifier 350 of certain embodiments described herein provides a means for identifying all the records (e.g., the entire table or branch of records corresponding to the subject of the user's request) that are expected to be potentially used by the user when creating recipes, making recipe modifications, and/or other desired operations. By using the third identifier 350 to identify the large number of records to be transmitted to the user, certain embodiments do not have to scale the computer-based system 100 to deal with many users, and can distribute the burden of further data operations to the user computing device 150. For example, by utilizing a computer-based database that is structured such that the lower-level records 320 each include a third identifier 350, certain embodiments transmit sufficient information to the user to allow the user to perform the desired operations without requiring that additional requests (e.g., dynamic, on-the-fly calls) for additional information be transmitted to the computer system 100 and without requiring the computer system 100 to respond to (e.g., process) these additional requests.

In certain embodiments, the received food-related query comprises a text string inputted by the user into the user computing device 150, which is running a software application that is configured to transmit the text string via the internet 140 to the computer system 100. The text string can comprise one or more words, phrases, sentences, and/or sentence fragments with which the user expresses a request for food-related information. For example, for a user seeking recipes that include a certain ingredient, the text string can mention the ingredient or a form of the ingredient, e.g., “whole chicken,” “chicken breast,” “apples,” “fruit,” In other examples, for a user seeking recipes that incorporate the use of a named piece of equipment (e.g., “barbeque”), the computer system 100 can return a set of recipes (e.g., comprising a predetermined number of recipes) using a barbeque. These recipes can be sorted by the number of barbequing minutes required by the recipe, which could be useful for users that may be running low on propane. In another example, the user can specify some description of a cooking or preparation method (e.g., soufflé; chopped; poaching), and the computer system 100 can return a set of recipes that utilize the specified cooking or preparation method or a list of equipment that can be used for the cooking or preparation method.

In certain embodiments, the query further comprises a realm identifier (e.g., an alphanumeric identifier) that identifies a realm (e.g., food-related topic) of the query. Examples of realms in accordance with certain embodiments described herein include but are not limited to: “Food,” “Equipment,” “Preparation,” “Recipe,” and “Restaurant.” In certain embodiments, the software application running on the user computing device 150 is configured to include the realm identifier in the food-related query that is transmitted to the computer system 100. For example, the text string can be inputted by the user into a user interface field of the software application running on the user computing device 150, with the user interface field corresponding to a particular realm (e.g., separate user interface fields corresponding to different realms or a user interface field which corresponds to a user-selected one of the realms), and the software application includes the corresponding realm identifier in the query with the text string. The user interface field can be equipped with an “auto-complete feature” which provides suggested completions of partially-types words and/or phrases, and the resulting complete text strings can have a high likelihood of having at least a portion which matches an alias table term, as described more fully herein. For another example, the computer system 100 can be configured to derive the realm identifier from the text string (e.g., by examining the text string for a portion that corresponds to a word or phrase indicative of one of the realms).

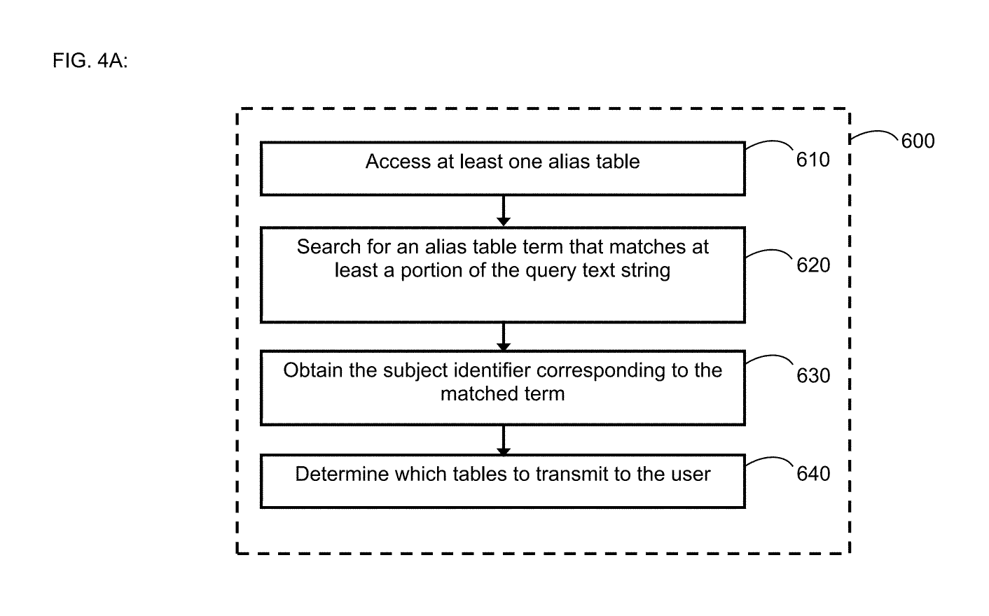

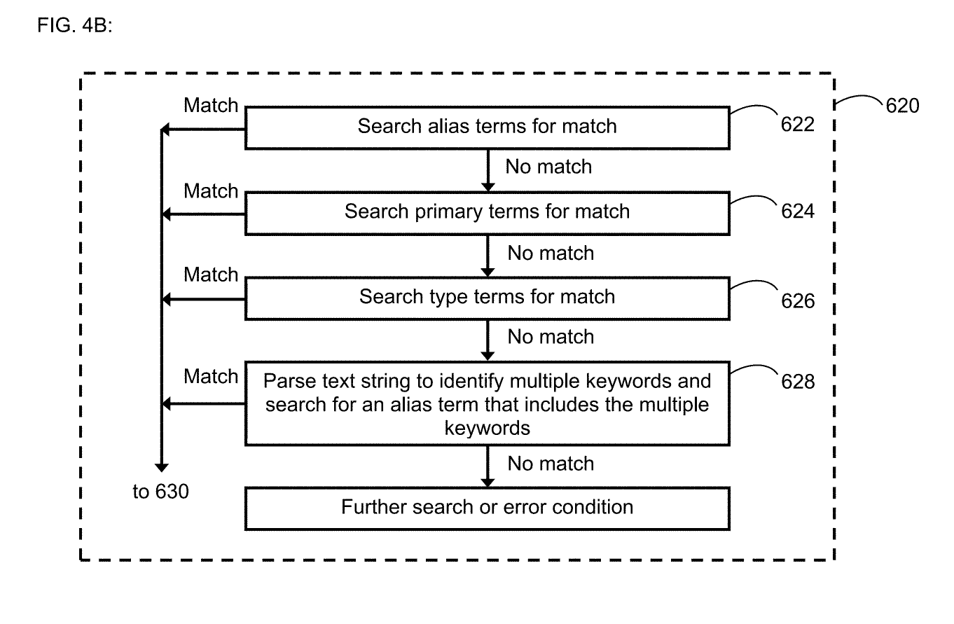

FIG. 4A is a flow diagram of an example method 600 performed in the operational block 220 for generating the subject identifier in accordance with certain embodiments described herein. In an operational block 610, the method 600 comprises accessing at least one alias table (e.g., the at least one alias table stored by the at least one memory device 120). In an operational block 620, the method 600 further comprises searching for a term of the at least one alias table that matches at least a portion of a text string of the query received from a user computing device 150. In an operational block 630, the method 600 further comprises obtaining (e.g., retrieving from the at least one alias table) a subject identifier that corresponds to the matched term of the at least one alias table. In an operational block 640, the method 600 further comprises determining, based at least in part on the subject identifier, the primary table and the at least one other table to be transmitted to the user.

In certain embodiments, the at least one alias table comprises a listing of terms (e.g., words; phrases) that a user is expected to potentially include in a food-related query to identify the subject for which the user seeks information (e.g., from the computer system 100). The at least one alias table can comprise a single table or multiple tables that are concatenated (e.g., unioned) together. For example, the at least one alias table can comprise one or more alias tables for each realm (e.g., food-related topic) expected to be relevant to the food-related query and accessing the at least one alias table comprises accessing one or more alias tables corresponding to the realm identified by the realm identifier. For example, the alias table for the “food” realm can contain more than 1.2 million records, and the alias table for the “equipment” realm can contain more than 8,000 records.

Each realm can comprise a plurality of sub-realms (e.g., tiers) and each sub-realm can comprise a plurality of primary terms. For example, the realm of “food” can include a sub-realm of types (e.g., categories) of food (e.g., “fruit,” “vegetable,” “meat”) and each type can include various primary terms (e.g., the type “fruit” can include primary terms such as “apple,” “orange,” “pear;” the type “vegetable” can include primary terms such as “broccoli,” “cauliflower,” “onion;” the type “meat” can include primary terms such as “chicken,” “beef,” “fish”). Other sub-realms of the “food” realm can include but are not limited to food brand (e.g., with primary terms corresponding to food brand names that the users may use in the queries), food manufacturer (e.g., with primary terms corresponding to names of food manufacturing companies that the users may use in the queries), and food providers (e.g., with primary terms corresponding to names of food selling companies that the users may use in the queries).

For another example, the realm of “equipment” can include a sub-realm of types (e.g., categories) of equipment (e.g., “oven,” “stove,” “pans,” “blenders”) and each type can include various primary terms (e.g., the type “oven” can include primary terms such as “convection,” “broiler,” “microwave”). For still another example, the realm of “preparation” can include a sub-realm of types (e.g., categories) of preparation techniques (e.g., “cutting,” “mixing,” “frying”) and each type can include various primary terms (e.g., the type “cutting” can include primary terms such as “slicing,” “dicing,” “dividing”). Various realms, sub-realms, and primary terms are compatible with certain embodiments described herein.

In certain embodiments, the one or more alias tables for each realm can comprise an alias table comprising terms corresponding to the names of the various types (e.g., “fruit,” “vegetable,” “meat”) and an alias table comprising terms corresponding to the primary terms (e.g., “apple,” “orange,” “pear,” “broccoli,” “cauliflower,” “onion, “chicken,” “beef,” “fish”). In certain such embodiments, the terms corresponding to the names of the various types and/or the primary terms are configured to be searched separately (e.g., as described herein with regard to FIG. 4B).

Each term of the at least one alias table has a corresponding subject identifier (e.g., a numeric identifier; a class identification number) that identifies the subject with which the term is associated. Multiple terms can be “aliases” of one another, effectively denoting the same subject, and such aliases each have the same subject identifier as one another. These aliases can reflect one or more differences from one another, including but not limited to: singular/plural differences, word order differences, phrasing differences, punctuation differences, and spelling differences. For example, the at least one alias table can include the term “boneless skinless chicken breast” with a corresponding subject identifier and the at least one alias table can further other terms that are aliases of the term “boneless skinless chicken breast” with the same subject identifier. Examples of such aliases can include but are not limited to the following terms:

“boneless skinless chicken breasts” (e.g., singular/plural difference)

“skinless boneless chicken breast” (e.g., word order difference)

“boneless, skinless chicken breast” (e.g., punctuation difference)

“boneless and skinless breast of chicken” (e.g., phrasing difference)

“boneless chicken breast without skin” (e.g., phrasing difference)

“boneless skinless chicken breast” (e.g., spelling difference)

“breast of chicken (boned and skinned)” (e.g., multiple differences).

FIG. 4B is a flow diagram of an example search of the operational block 620 in accordance with certain embodiments described herein. In an operational block 622, the alias terms of the at least one alias table are searched for a match (e.g., an exact match; a literal match) of the text string of the query. If a match is found, then the search proceeds to the operational block 630, and if a match is not found, then the search proceeds to an operational block 624. In the operational block 624, the primary terms are searched for a match (e.g., an exact match; a literal match) of the text string of the query. If a match is found, then the search proceeds to the operational block 630, and if a match is not found, then the search proceeds to an operational block 626. In an operational block 626, the type terms are searched for a match (e.g., an exact match; a literal match) of the text string of the query. If a match is found, then the search proceeds to the operational block 630, and if a match is not found, then the search proceeds to an operational block 628. In the operational block 628, the text string is parsed into multiple keywords (e.g., parsing based on conjunctions and/or punctuation within the text string). For example, a text string of “steak and potatoes” can be parsed into a first keyword “steak” and a second keyword “potatoes.” The alias terms of the at least one alias table are then searched for an alias term that matches the multiple keywords (e.g., includes each of the multiple keywords in any order). If a match is found, the search proceeds to the operational block 630, and if a match is not found, then the search either proceeds to further searches (e.g., parsing the text string in other ways) or to an error condition (e.g., “search failed”).

In certain embodiments, the subject identifier of the matched term is obtained (e.g., retrieved from the at least one alias table) in the operational block 630 and based at least in part on the subject identifier, the multiple tables to be transmitted to the user are determined in the operational block 640. The multiple tables to be transmitted include (i) the table in which the lower-level records have third identifiers that correspond to the subject identifier of the matched term (e.g., the primary table) and (ii) at least one other table which includes records which are potentially useful to the user.

In certain embodiments, determining the at least one other table to be transmitted to the user is further based on other information (e.g., the realm identifier from the query; an identifier of the particular alias table in which the match was found). In certain embodiments, at least one template of a plurality of templates is accessed and used to determine this at least one other table (e.g., based on the subject identifier retrieved from the at least one alias table). Each template of the plurality of templates can specify a different set of other tables to be transmitted to the user, and this set of other tables can include tables which vary from the primary table in one or more attributes (e.g., type; variety; form; ingredients; preparation techniques; equipment to be used) that the user may seek to adjust while using the information.

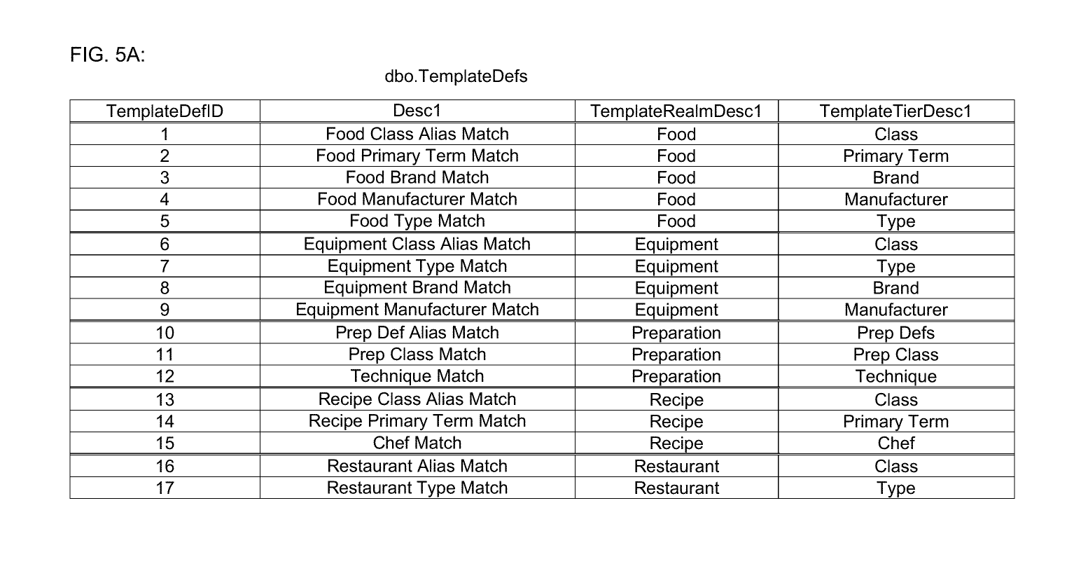

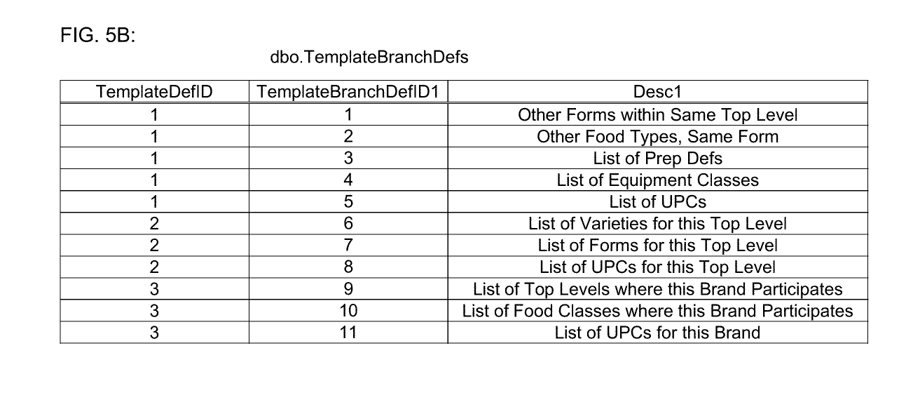

FIG. 5A schematically illustrates an example list of templates (dbo.TemplateDefs) in accordance with certain embodiments described herein and FIG. 5B schematically illustrates a portion (e.g., corresponding to one of the templates) of a list of other tables (dbo.TemplateBranchDefs) in accordance with certain embodiments described herein. For each of the templates listed in FIG. 5A, the list of other tables (dbo.TemplateBranchDefs) of FIG. 5B can specify a corresponding different set of multiple other tables. These other tables can include but are not limited to: tables corresponding to other varieties of the subject of the primary table; tables corresponding to other forms of the subject of the primary table; tables corresponding to preparation definitions (e.g., techniques) compatible with the subject of the primary table; tables corresponding to equipment classes compatible with the subject of the primary table; tables corresponding to universal product codes (UPCs) relevant to the subject of the primary table. In certain embodiments, other information (e.g., static text files; image files), in addition to the primary table and the other tables, is transmitted to the user.

For example, in the food realm, if the subject identifier of the matched term is one of the food alias terms, then the template having TemplateDefID=1 is used to specify the at least one other table. As shown in FIG. 5B, for this template (TemplateDefID=1), the at least one other table includes (i) tables corresponding to other forms within the same top level as that of the primary table, (ii) tables corresponding to other food types with the same form as that of the primary table, (iii) tables corresponding to preparation definitions (e.g., techniques) compatible with the food of the primary table, (iv) tables corresponding to equipment classes compatible with the food of the primary table, and (v) tables corresponding to universal product codes (UPCs) relevant to the food of the primary table. For another example, if the subject identifier of the matched term is one of the food primary terms, then the template having TemplateDefID=2 is used to specify the at least one other table, which as shown in FIG. 5B, includes (i) tables corresponding to other varieties for the same top level as that of the primary table, (ii) tables corresponding to other forms for the same top level as that of the primary table, and (iii) tables corresponding to UPCs for the same top level as that of the primary table. For still another example, if the subject identifier of the matched term is one of the food brands, then the template having TemplateDefID=3 is used to specify the at least one other table, which as shown in FIG. 5B, includes (i) tables corresponding to other top levels with which the brand of the primary table participates, (ii) tables corresponding to other food classes with which the brand of the primary table participates, and (iii) tables corresponding to UPCs of the brand of the primary table.

If the subject identifier of the matched term is one of the food primary terms, then the template having TemplateDefID=2 is used to specify the at least one other table; if the subject identifier of the matched term is one of the food brand terms, then the template having TemplateDefID=3 is used to specify the at least one other table, etc. Various other sets of templates and sets of tables specified by each template are compatible with certain embodiments described herein.

In certain embodiments, once the primary table (e.g., the table with lower-level records having third identifiers that correspond to the at least one subject identifier) and the at least one other table (e.g., the tables specified by the appropriate template) are determined, the at least one computer database is accessed in the operational block 230 and all these tables are retrieved and transmitted (e.g., via the internet 140 from the computer system 100) to the user (e.g., the user computing device 150) in the operational block 240. For example, the transmitted data sets can be arranged in a series of JSON formatted responses, that are then transmitted via encrypted TCP packets to the client device (e.g., the user computing device 150). In certain embodiments, other information (e.g., static text files; image files), in addition to the primary table and the other tables, is transmitted to the user.

### Node-to-Node Structure

The node-to-node system can provide a large amount of static, yet connected data, which can span tens of millions of connected records in a relational database. By spelling out the data points and their connections, the node-to-node system described herein can advantageously utilize less overhead in machine time to find requested data. In contrast, conventional text-based food and recipe systems search a database for text-based data using proximal estimates of the expected location of the data, and if the correct data is not found, then determining how best to proceed, and these multiple adjustments can create a massive burden on the computer hardware to keep up with all the searching.

In certain embodiments, the node-to-node system provides a “skeleton” structure which forms the backbone of supporting food and recipes. Each standard node-to-node segment can be set up one time and used many times. In certain embodiments, the node-to-node system supports a standard and a multiplicity of variants, e.g., between any two nodes, as an ending node, as a beginning node, a series of nodes, a network segment, and a series of network segments. In certain embodiments, individual users can specify their own standards and a multiplicity of variants.

In certain embodiments, one recipe has a multiplicity of methods/techniques and equipment that is customized for each user's unique preferences. In certain embodiments, standards enable recipes to be compared and contrasted based on the standard and/or any of its variants. They recipes can be compared or contrasted by the ingredients, methods/techniques, or the equipment used.

In addition to the node-to-node standards, in certain embodiments there is also an actor. The actor can be passive (e.g., an oven where heat is applied when baking in an Oven). The actor can be the device, person, robot, or equipment that takes some level of action in the specific conversion process from State A to State B. In the case of equipment, the actor may load or unload the food items into or out of the equipment, if the equipment doesn't have the capability.

The basic building blocks of the node-to-node structure are “States” and “Actions.” The “state” of an item can comprise a form of an item and/or a temperature of the item. An “action” changes the state of an item, for example, by changing the form of the item and/or the temperature of the item. Each action of a node-to-node segment can have a time duration and, if appropriate, temperature, speed, humidity, and pressure.

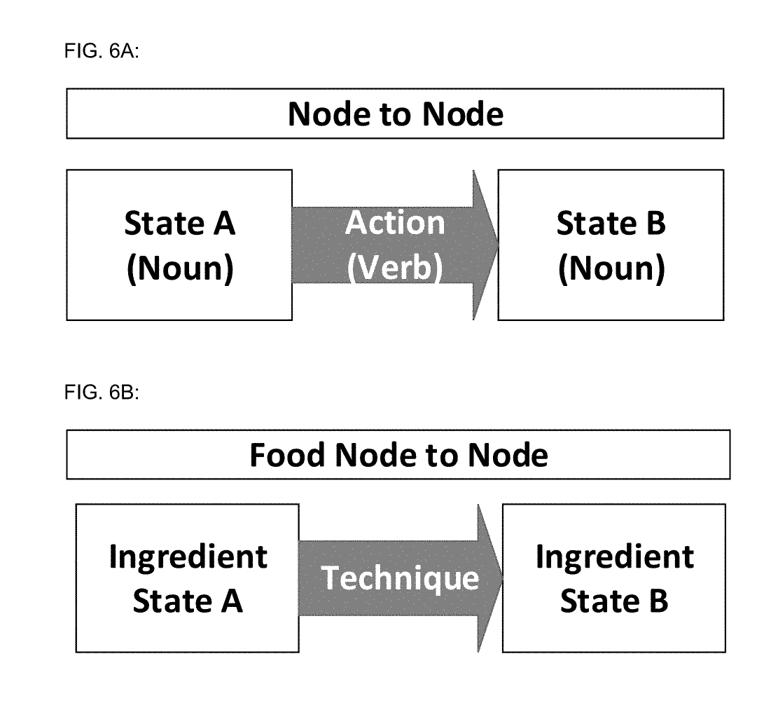

FIG. 6A schematically illustrates the relationship between states and actions for a general node-to-node segment in accordance with certain embodiments described herein. The item is in State A and an Action changes the item into State B. FIG. 6B schematically illustrates an example node-to-node segment for a food and recipe network in accordance with certain embodiments described herein. The ingredient in State A is node 1 which is connected by the action to node 2 which is the ingredient in State B. In this example, the item (e.g., a food ingredient or a plurality of ingredients) is changed from State A to State B by the technique (e.g., action) that is performed to change the item from State A to State B. For example, a “Fresh Apple” (e.g., item in State A) can be changed to “Fresh Apple Halves” (e.g., item in State B). The technique (e.g., action) employed between State A and State B is “Halving with a Chef Knife.” An action can be performed by hand, or in conjunction with a tool or plurality of tools (e.g., tools, containers, surfaces, equipment, etc.). In certain embodiments, the node-to-node segment for a food and recipe network includes inbound ingredients (Noun) in State A, applying a technique which includes using one or more tools (Verb) to produce an output (Noun) in State B. In certain embodiments, this Node B becomes the Node A in another subsequent instance of a node-to-node segment downstream of the node-to-node segment of FIG. 6B.

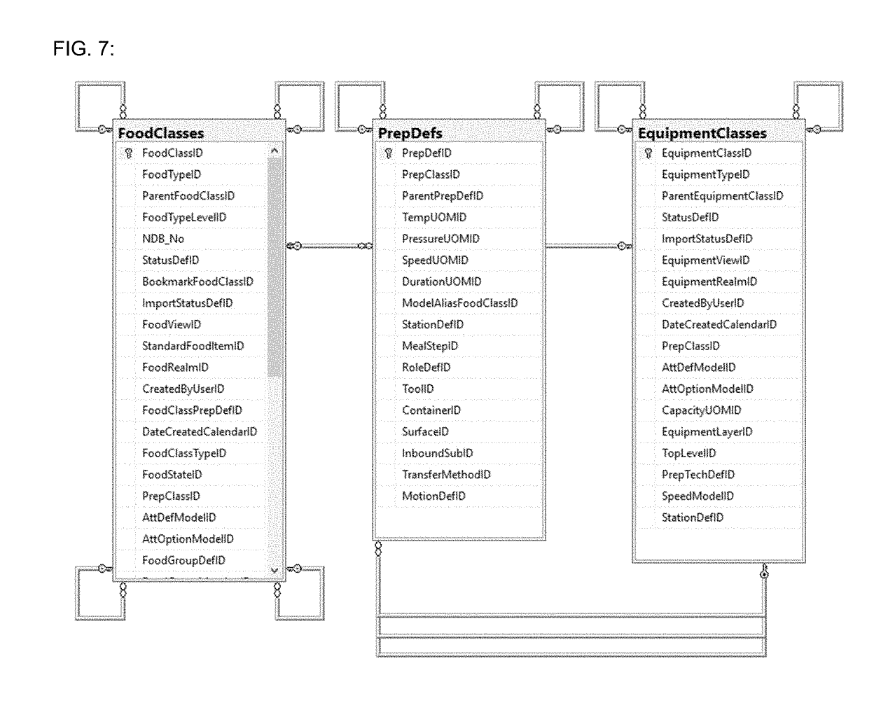

In certain embodiments, the at least one computer database organized in the node-to-node structure supports categorical definitions of the Foods, Preparation Methods, and Equipment that constitute the states and the actions of the node-to-node structure. For example, FIG. 7 schematically illustrates example multiple database tables and their relationships (e.g., associations) relative to one another that facilitates the node-to-node structure in accordance with certain embodiments described herein. As used herein, the terms “database table” and “table” have their broadest reasonable interpretation, including but not limited to, a set of cells or data elements (e.g., values) organized in a specified number of columns (e.g., vertical columns; identifiable by name) and any number of rows (e.g., horizontal rows), with each cell being where a row and a column intersect one another. As used herein, the term “database relationship” has its broadest reasonable interpretation, including but not limited to, the associations between the tables, and can include three types of relationships: (i) “one-to-one” in which both of two tables has only one record on either side of the relationship, and each primary key value relates to only one (or no) record in the related table; (ii) “one-to-many” in which the primary key table contains only one record that relates to none, one, or many records in the related table; and (iii) “many-to-many” in which each record in both tables can relate to any number of records (or no records) in the related table. As an analogy of the “many-to-many” relationship, if you have several siblings, each of your siblings also has many siblings. “Many-to-many” relationships can utilize a third table, known as an associate or linking table. As schematically illustrated in FIG. 7, the tables can have recursive relationships unto themselves, to support lower-level divergence, in both form and class. As used herein, the naming convention for the primary keys, in each table, is the Table name in its singular format concatenated with ID (e.g., dbo.FoodClasses and FoodClassID; dbo.PrepDefs and PrepDefID).

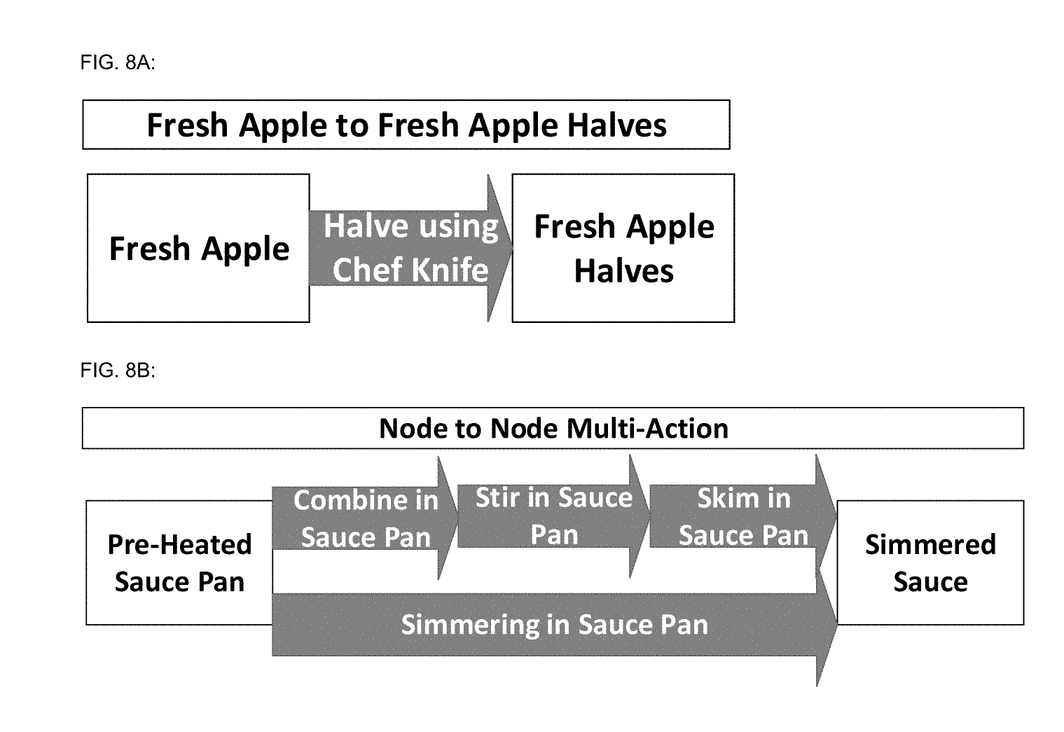

FIG. 8A schematically illustrates an example segment in which the nodes are connected by a single overall action/technique in accordance with certain embodiments described herein. In FIG. 8A, the item “Fresh Apple” is changed to the item “Fresh Apple Halves” by the technique of “Halve using Chef Knife.” FIG. 8B schematically illustrates an example segment in which the nodes are connected by two or more separate, distinct actions/techniques in accordance with certain embodiments described herein. In FIG. 8B, the sauce pan is preheated, then when hot, the ingredients are combined, then stirred and then skimmed until the items are made into a simmered sauce. The multiple actions can also be grouped (e.g., nested) together, effectively forming a single overall technique, e.g., the combining, stirring, and skimming can be grouped together as “simmering” as shown in FIG. 8B. In this example, there is a change in state of a cold sauce pan being brought up in temperature to become a “pre-heated sauce pan,” and there is a series of actions that happen in sequence to create the sauce. For an example scenario, from State A, a first Oil can be pre-heated or butter melted, then various room temperature ingredients can be mixed in and allowed to simmer, creating the “simmered sauce” of State B. For another example scenario, from State A, the room temperature ingredients can be combined, brought to a boil, and then allowed to simmer, creating the “simmered sauce” of State B. There are a multitude of possible ways or scenarios to make a sauce, but the state change is happening to the main “Actor” in the recipe. The sauce pan may be viewed as the “Actor,” the oil may be viewed as the “Actor,” the mixed sauce may be viewed as the “Actor,” and the simmered sauce may be viewed as the final result. In essence, what is changing from State A to State B can be the equipment or the ingredients.

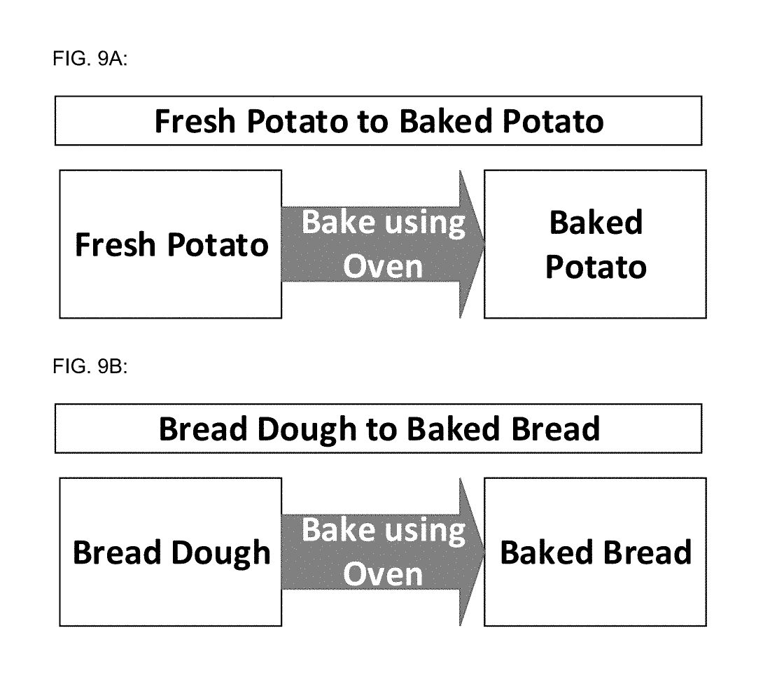

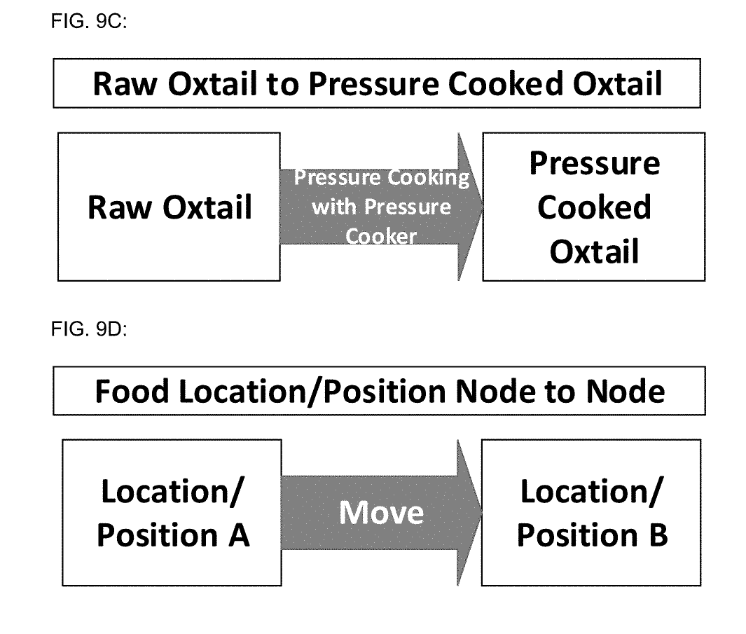

In certain embodiments, the change from State A to State B is a change of form, a change of temperature, a change of humidity, a change of pressure or vacuum, a change of location or position, or a combination thereof. FIGS. 8A and 9A-9D schematically illustrate example segments in accordance with certain embodiments described herein. FIG. 8A shows an example segment with a form change in which one Fresh Apple changes form by being cut in half using a chef knife which creates two Apple Halves (e.g., the form changed from a whole apple to two apple halves). FIG. 9A shows an example segment with a temperature change in which one Fresh Potato is baked in an oven which creates one Baked Potato. The temperature of the item is changed from room temperature to an internal temperature of 210° F. by baking it at 375° F. for 50 minutes. FIG. 9B shows an example segment with both a temperature and form change in which one pound of dough is baked in an oven until it transforms into baked bread. The dough is transformed into a new form from dough into baked bread. FIG. 9C shows an example segment with a pressure or vacuum change in combination with a temperature change in which one raw oxtail portion is cooked by Pressure Cooking with a Pressure Cooker to make a Pressure Cooked Oxtail. FIG. 9D shows an example segment with a location or position change (e.g., a grilled steak is positioned by Flipping with a Turner to cook the other side, and the location of the grilled steak is moved from the Barbecue Grill to the Serving Platter).

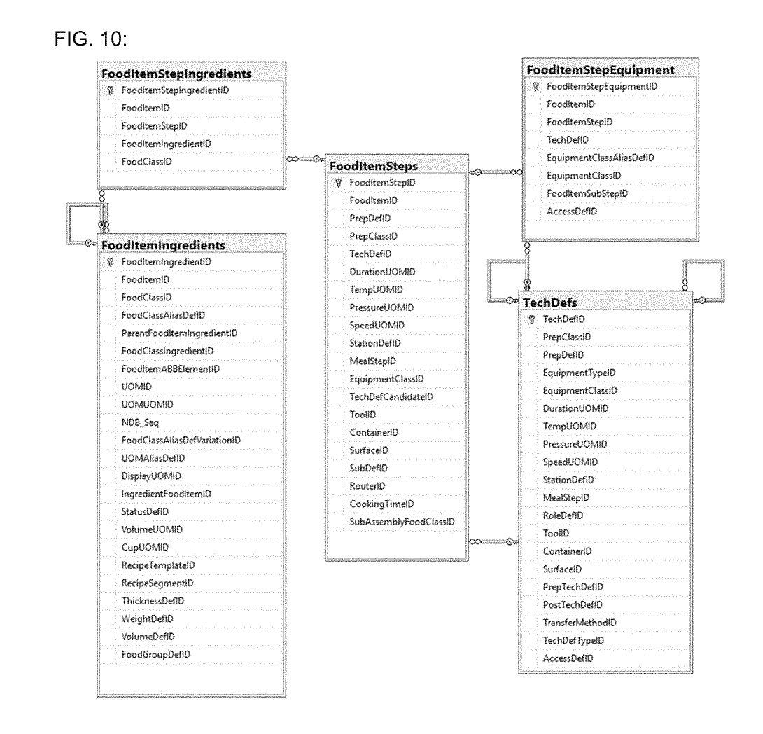

In certain embodiments, the at least one computer database is configured to support a constant connection between Ingredients, Equipment, and Techniques used in a single step of a recipe. FIG. 10 schematically illustrates an example set of database tables in accordance with certain embodiments described herein. These database tables can be the inner-workings of the recipe instructions, making use of commonly-named foreign keys to extend back to their appropriate definitions tables. Each step in the recipe instructions can be assigned a “SeqOrder” or sequence order value (1 to Step 1, 2 to Step 2, etc.). Moreover, the gross list of ingredients can be correlated with the Recipe Step in which they are introduced.

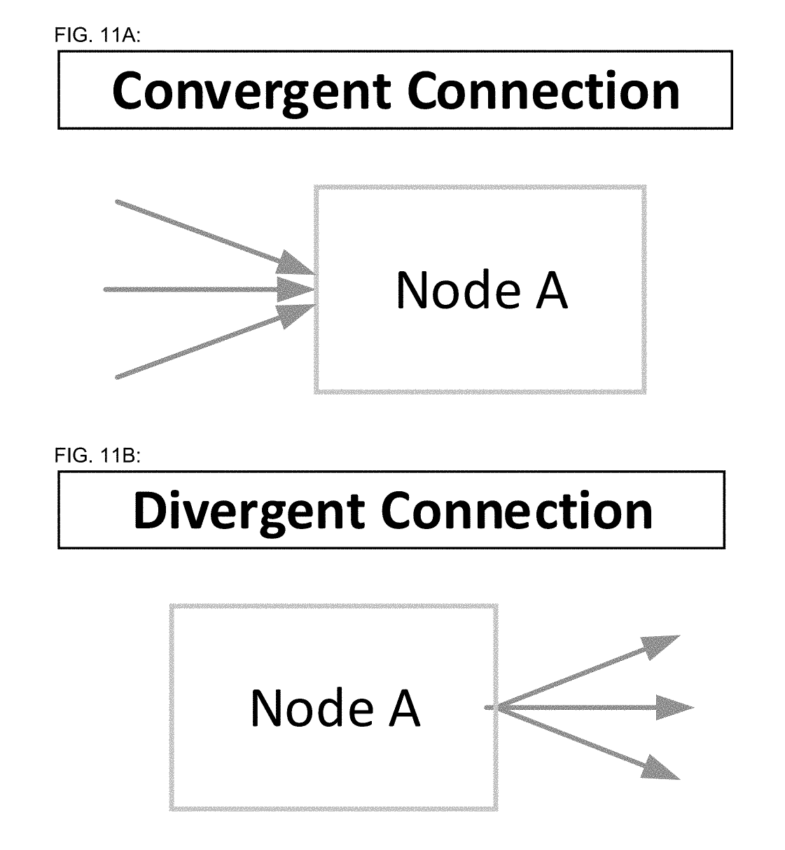

In certain embodiments, the nodes are connected to each other by a technique or by a series of techniques that are used to convert the item or ingredient from State A to State B. For example, FIG. 11A schematically illustrates an example convergent connection in accordance with certain embodiments described herein, in which multiple nodes go into one or more techniques (e.g., one or more connectors converge into a node), producing a single node (Node A in FIG. 11A). For another example, FIG. 11B schematically illustrates an example divergent connection in accordance with certain embodiments described herein, in which one node (Node A in FIG. 11B) goes into one or more techniques (e.g., one or more connectors diverge from a node), resulting in multiple nodes leaving it.

The at least one computer database of certain embodiments couples (e.g., “stitches”) single instances of a node-to-node model, with downstream instances of other node-to-node models, in a simple linear set of recipe instructions, an extended set of linear instructions, a convergent set of instructions, a divergent set of instructions, or any complex combination of linear, extended linear, convergent, and divergent set of instructions. For a set of simple linear instructions, the at least one computer database can create using a single node-to-node structure (e.g., the most basic model) which can include a single ingredient, a single technique, and a single set of tools, that result in a single ingredient. For example:

| Node A | Technique | Node B |
|---|---|---|
| 1 lb Frozen Hamburger | Thaw in a Refrigerator | 1 lb Hamburger |
| | | (thawed) |

For a set of extended linear instructions, the at least one computer database can use a single node-to-node structure that contains multiple steps and which can include a single ingredient, a series of multiple techniques, each with its own set of tools, that result in a single ingredient. For example:

| Node A | Technique 1 | Technique 2 | Technique 3 | Node B |
|---|---|---|---|---|
| 1 lb | Place | Knead the | Form the | 1 Hamburger |
| Hamburger | Hamburger | Hamburger | Hamburger | Patty (1 lb) |
| (thawed) | on Clean | by hand. | into a Single | |
| | Surface | | Patty by hand | |

For a convergent set of instructions, the at least one computer database can use multiple node-to-node networks (e.g., instances), each of which results in a single ingredient, which are then used as ingredients in a third node-to-node network, which results in a single ingredient. For the following example, Network I and Network II feed into Network III:

Network I

| | Tech- | Tech- | Tech- | Tech- | Tech- | |
|---|---|---|---|---|---|---|
| Node A | nique 1 | nique 2 | nique 3 | nique 4 | nique 5 | Node B |
| 1 Ham- | Preheat | Place | Grill | Flip | Grill | 1 |
| burger | Gas | Ham- | Ham- | Ham- | Ham- | Grilled |
| Patty | Grill | burger | burger | burger | burger | Ham- |
| (1 lb) | | Patty on | Patty for | Patty | Patty for | burger |
| | | Preheated | 3 minutes | | 3 minutes | Patty |
| | | Grill | | | | |

Network II

| Node A | Technique 1 | Technique 2 | Technique 3 | Node B |
|---|---|---|---|---|
| 3 | Preheat lightly | Place | Saute | 3 |
| Mushrooms | oiled Saute Pan | Mushroom | Mushroom | Mushrooms |
| (halved) | | Halves in the | Halves for 5 | (halved and |
| | | Preheated | Minutes | sauteed) |
| | | Saute Pan | | |

Network III

| | Nodes A | Technique 1 | Technique 2 | Node B |
|---|---|---|---|---|
| A1 | 1 Grilled | Place Grilled | Scoop the Sauteed | Grilled |
| | Hamburger Patty | Hamburger | Mushroom Halves | Hamburger |
| A2 | 3 Mushrooms | Patty on | on top of the | and |
| | (halved and | a Plate | Hamburger Patty | Mushrooms |
| | sauteed) | | | |

For a divergent set of instructions, the at least one computer database can use a single ingredient in one node-to-node network (e.g., instance), which results in multiple ingredients, which are then used, each individually, as single ingredient inputs to other node-to-node networks, each of which results in one or more ingredients. For the following example, Network I diverges into Network II and Network III:

Network I

| | | |
|---|---|---|
| Node A | Technique 1 | Nodes B |

| | | | |
|---|---|---|---|
| 1 Fresh | Core Apple with Corer | 1 Apple (cored) | B1 |
| Apple | | 1 Apple Core | B2 |

Network II

| | | |
|---|---|---|
| Node A | Technique 1 | Node B |

| | | | |
|---|---|---|---|
| 1 Apple | Peel with a Peeler | 1 Apple (cored | B1 |
| (cored) | | and peeled) | |
| | | Apple Peel | B2 |

Network III

| Node A | Technique 1 | Node B | |
|---|---|---|---|
| 1 Apple Core | Seed Removal with Knife | Apple Seeds | B1 |
| | | Apple Core | B2 |
| | | (seeded) | |

For a set of complex combination instructions, the at least one computer database can use any single or multiple ingredients, feeding a combination of convergent, linear, and/or divergent structures, which collectively result in one or more ingredients. For the following example, multiple ingredients converge into a Sourdough Bread recipe, which is then halved, half for baking and half for storing (e.g., to be used as a starter mixture to make the next batch of sourdough):

| | | | | | | |
|---|---|---|---|---|---|---|
| 1 tablespoon | Starter | Sourdough | Halve | Half | Bake | Sourdough |
| active dry yeast | Mixture | Dough | | A | | Bread |
| starter | | | | | | |
| 75 grams (½ cup) | | | | | | |
| all-purpose flour | | | | | | |
| 75 grams (⅓ cup) | | | | | | |
| water | | | | | | |
| 1 tablespoon salt | Dough | | | Half | Store | Aged |
| | Mixture | | | B | | Sourdough |
| 525 grams | | | | | | Dough |
| (2½ cups) water | | | | | | (Starter |
| | | | | | | Mixture) |
| 700 grams | | | | | | |
| (5½ cups) | | | | | | |
| all-purpose flour | | | | | | |

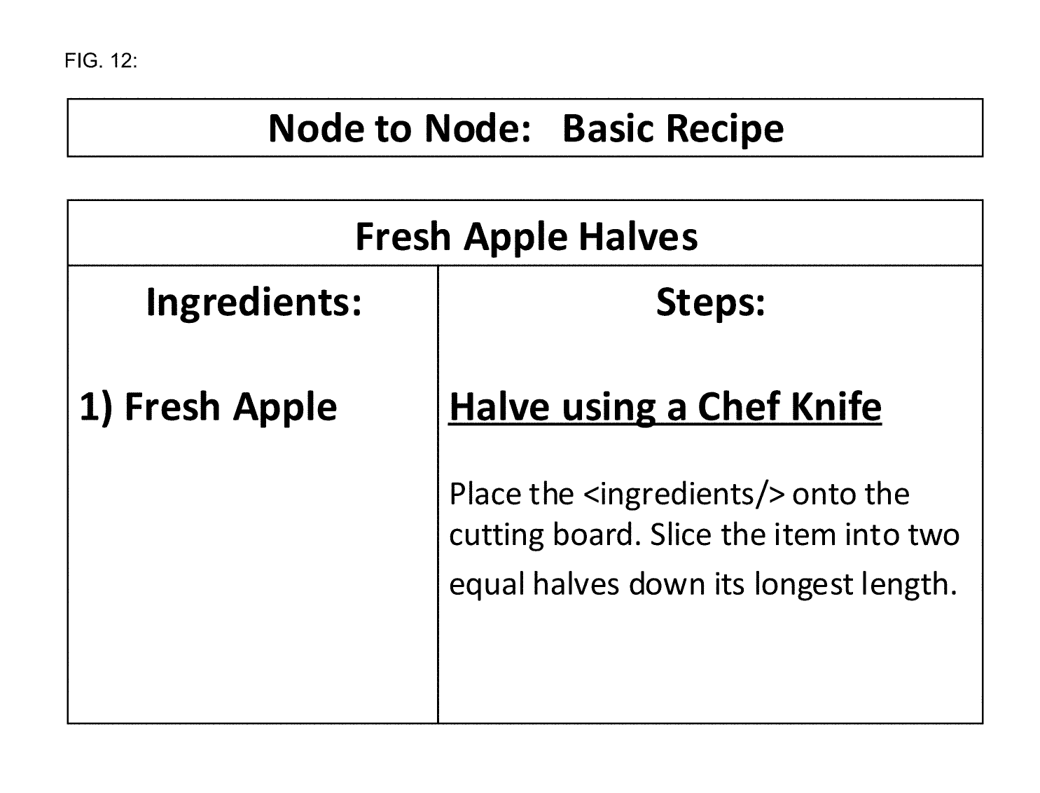

FIG. 12 schematically illustrates a basic recipe node-to-node network (e.g., instance) in accordance with certain embodiments described herein. The network comprises a title (e.g., output) of the recipe, the ingredients (e.g., inputs) of the recipe, and the steps and description (e.g., actions) to turn the ingredient inputs into the recipe output.

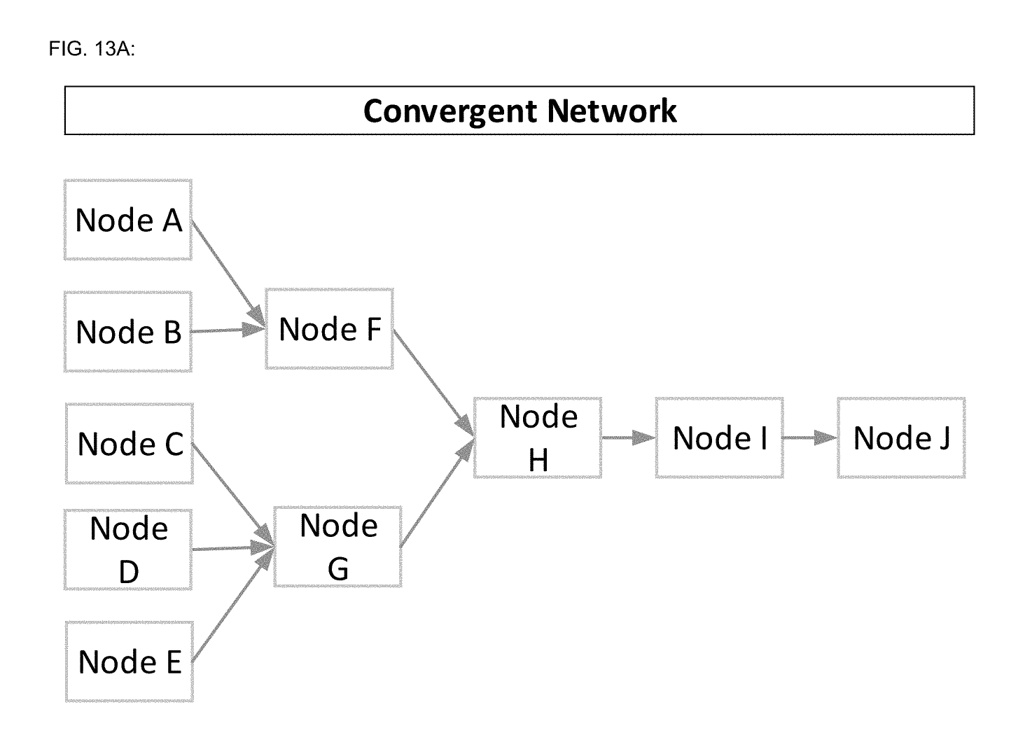

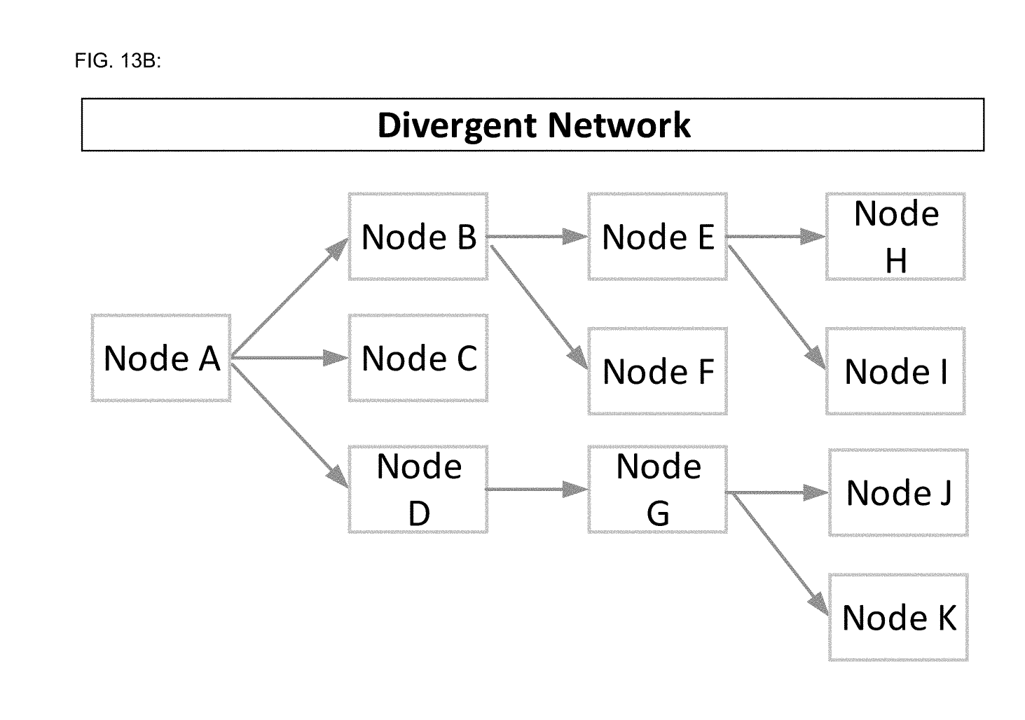

FIG. 13A schematically illustrates a convergent node-to-node network in accordance with certain embodiments described herein. The nodes are connected in a way that they continue to converge until the final node in the network. For example, an Apple Pie uses many ingredients that are prepared into two forms: a filling and a pie crust. These ingredients are assembled and then baked to transform them into an Apple Pie. FIG. 13B schematically illustrates a divergent node-to-node network in accordance with certain embodiments described herein. The nodes are connected such that they derive from one node and continue to have various forms. For example, a Fresh Apple can be cut in half to produce Apple Halves, the Apple Halves can have the seeds removed creating Seedless Apple Halves, and the Seedless Apple Halves can be cut in half to create Seedless Apple Quarters. The Fresh Apple can also be cored to create a Cored Apple. The Cored Apple can then be peeled into an Apple (Peeled & Cored). The network continues to diverge until all possible forms are connected via the node-to-node structure.

In certain embodiments, there are also combinations of a divergent network connected with a convergent network or a convergent network connected to a divergent network, ad infinitum. For example, for a divergent network connected to a convergent network, a Fresh Apple can be the beginning of a divergent network with all the various Apple derivative forms, and many of these forms (e.g., Seeded Sliced Apples) can be used in a convergent network (e.g., an Apple Pie). For example, for a convergent network connected to a divergent network, Making Bread can be a convergent network in which various flour mixes are combined to form a Bread Dough, and the Bread Dough is then baked, creating Baked Bread. The Baked Bread can then be made into Bread Crumbs which can be called out in a multitude of recipes, creating a divergent network into many recipes which use Bread Crumbs (e.g., crab cakes, breaded meats, breaded poultry, fillings, stuffing, etc.). In another example of a divergent network, Baked Bread can be sliced into Slices, which are then toasted in a toaster, creating Toasted Bread Slices. The Toasted Bread Slices are then buttered with a butter knife to create Toasted Buttered Bread Slices.

The food side of cooking is where the food is changed into a state useful for use in a recipe. The recipe can have certain food ingredients that are in a particular state to be used in the recipe, where they are transformed into a given final state. When starting with the Live/Fresh/Raw State of a given ingredient and then changing its form, there can be many different forms in which the changed ingredients can be used. For example, an Apple can be cut into halves, its seeds can be removed, it can be cut into quarters, or the Apple can be cored, then peeled and cut into peeled halves. The result of all the forms of an apple is a divergent network, where the network branches into more and more nodes. Each node can represent a possible ingredient which can be used directly into a recipe.

When starting with a recipe, all the ingredients can be provided in the forms dictated by the recipe before cooking. The French call this Mise en Place, which is everything ready and in place. The recipe can call out the item in a state. A recipe can start with one or more ingredients which can be combined together into one final form by the end of the recipe. Recipes can start with many things that then become one, which can be a convergent network, with all the nodes and ingredients leading to one final ingredient. This is like assembling a car, where thousands of parts produce one single item.

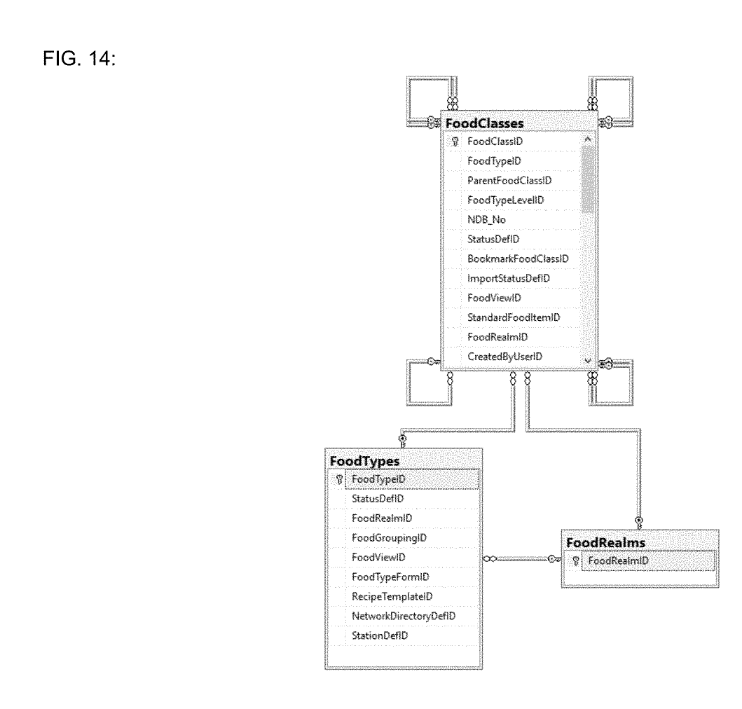

FIG. 14 schematically illustrates an example set of database tables in accordance with certain embodiments described herein. The computer database splits the dbo.FoodClasses table (and corresponding dbo.FoodTypes table) into two halves, marked with foreign key connection to dbo.FoodRealms. Food Classes with a single item ingredient can reside within the “Food” realm, and Food Classes with two or more ingredients can reside within the “Recipe” realm.

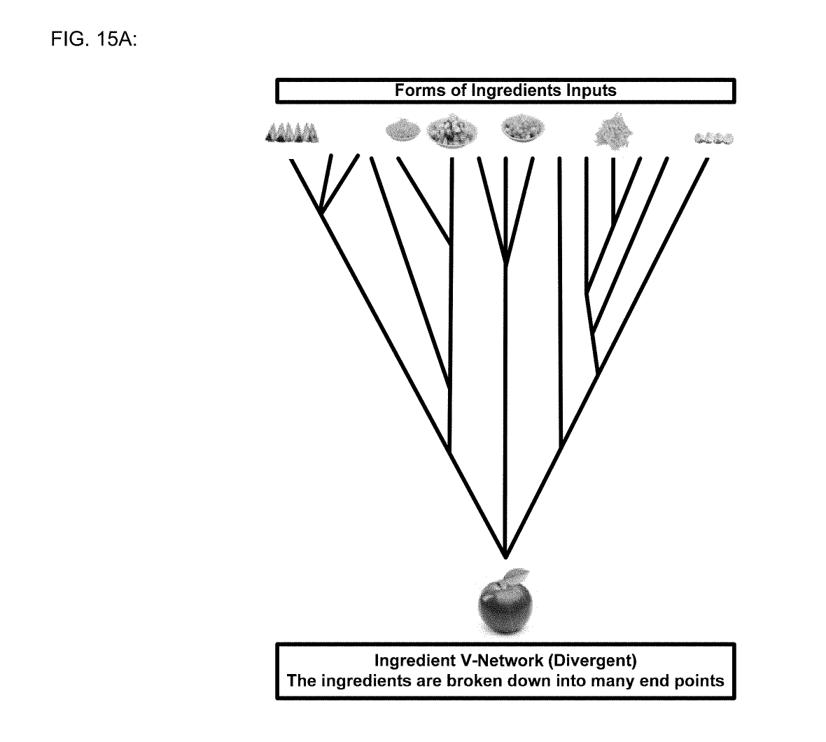

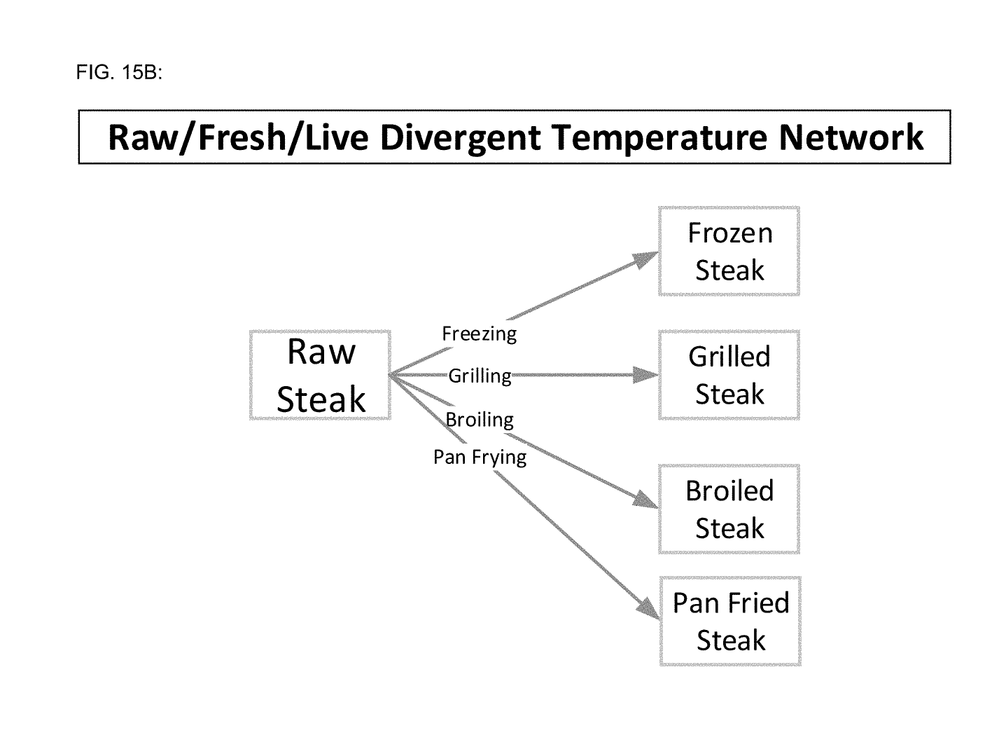

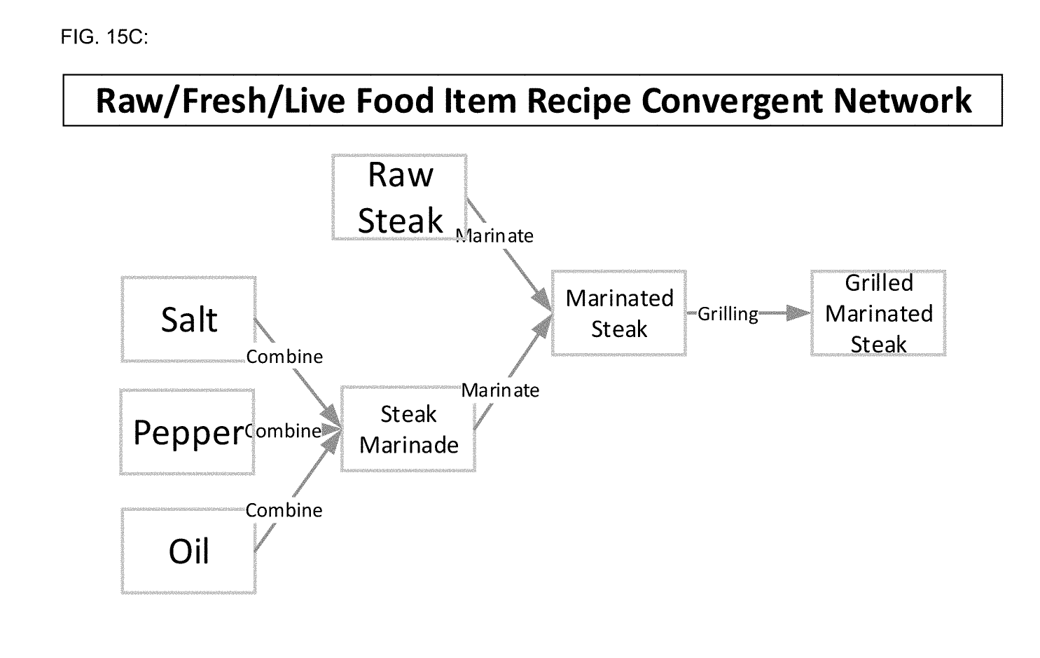

FIG. 15A schematically illustrates an example ingredient network (e.g., for Apple) having a V-network divergent structure in accordance with certain embodiments described herein. Ingredients generally start in their Live, Fresh or Raw state. An ingredient can be used fresh or it can be prepared by hand or by tools to convert into a form useful in a recipe. For example, an Apple has an ingredient network in the shape a “V” (e.g., a V-network), where each form of the ingredient is different. The ingredient network can be divergent, where each form of the ingredient is a derivative of the raw form where it is still identifiable. In certain embodiments, the Food realm covers the ingredients and their basic forms for use in a recipe. For example, a raw New York Steak can be in the Food realm. Where the food item is cooked or mixed with other ingredients, then it can be part of the Recipe realm.

FIG. 15B schematically illustrates an example divergent temperature change network (e.g., for Steak) in accordance with certain embodiments described herein. The raw New York Steak can be flash frozen, refrigerated or cooked, such as grilled, pan fried or broiled. This pivot can connect the Live, Fresh or Raw form to its possible cooking/freezing/refrigerating preparation methods. FIG. 15C schematically illustrates an example food item recipe convergent network in accordance with certain embodiments described herein. As shown in FIG. 15C, the raw steak can be part of the set of convergent steps to create a Grilled Marinated Steak. The other ingredients can connect into the recipe convergent network via flavoring methods prior to cooking as well (e.g., the New York Steak can be flavored by seasoning, rubbing, marinating, etc.). This preparation for flavoring can be on the recipe side which are generally convergent networks.

The Food realm can comprise divergent networks from a given raw/fresh/live ingredient, starting with the ingredient in its beginning Live, Fresh or Raw state, and all the derivative forms connected to this beginning state. The derivative forms also can be connected to their state where the temperature is changed (e.g., frozen, refrigerated, cellared, dried, cooked, etc.). There can also be derivative products produced by certain food processing techniques, which can be referred to as derivative food products. For example, Corn can be separated into its component germ, bran, starch, oil, etc., which are all derivatives of Corn and can form part of its divergent food network.

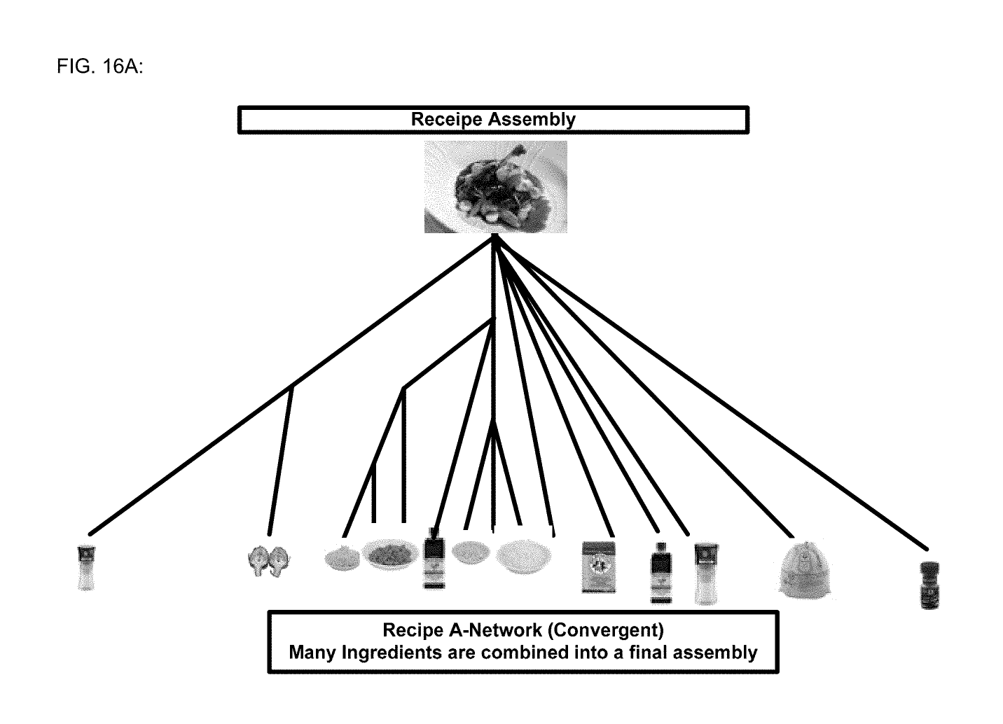

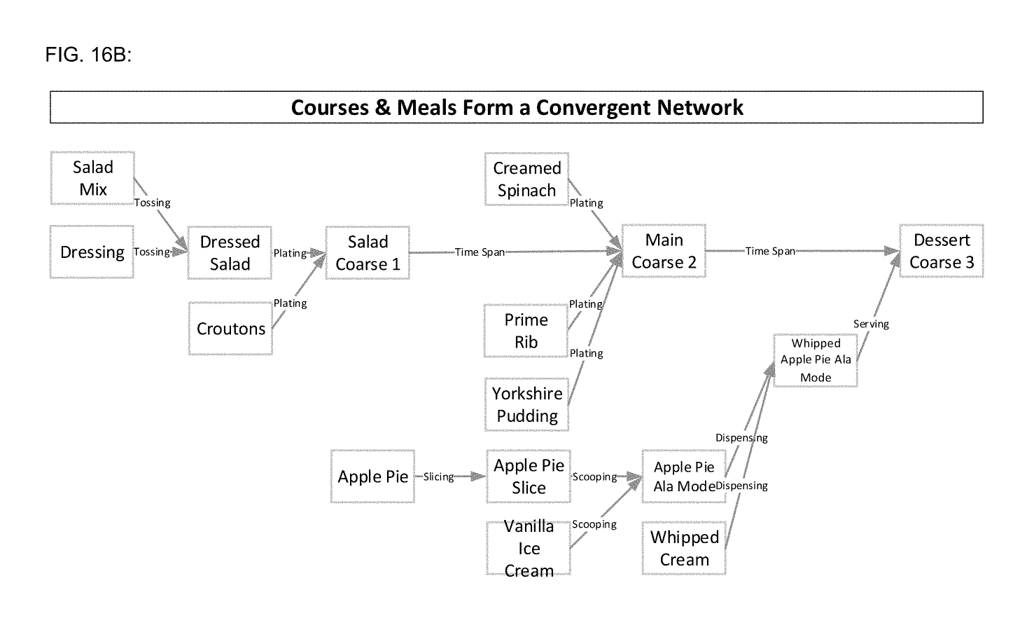

FIG. 16A schematically illustrates an example recipe network having an A-network convergent structure in accordance with certain embodiments described herein. Recipes can be the conversion of one item from one form to another, which changes its state and/or its temperature. Recipes are generally (but not always) a convergent network in which one or more ingredients can be used to make a final item (e.g., many ingredients can be combined and prepared in various ways into a final assembled dish). The dissimilar ingredients can be combined in various ways to form a final singular outcome. As shown in FIG. 16A, the network can be the shape of an “A,” in which there are many inputs culminating in one final output (e.g., a convergent network).

A meal can be another example of a convergent network, where a meal comprises various recipes. For example, Roasted Prime Rib with Yorkshire Pudding and Creamed Spinach can be a main dish for a meal. Each of the individual items can have its own recipe (e.g., recipes for Roasted Prime Rib, Yorkshire Pudding, and Creamed Spinach). Together, these three recipes can converge and form the main dish of the meal. A meal can also comprise one or more courses. Courses can be sequential servings of the overall meal. Each course can be a convergent network to form the course of that meal. FIG. 16B schematically illustrates an example convergent network in which three courses form a meal in accordance with certain embodiments described herein. The first course can be a salad, the second course can be a main dish, and the final course can be a dessert. Each course can comprise one or more recipes which can be performed to serve the course. The courses can be separated by a time span between them or can be served in parallel with one another.

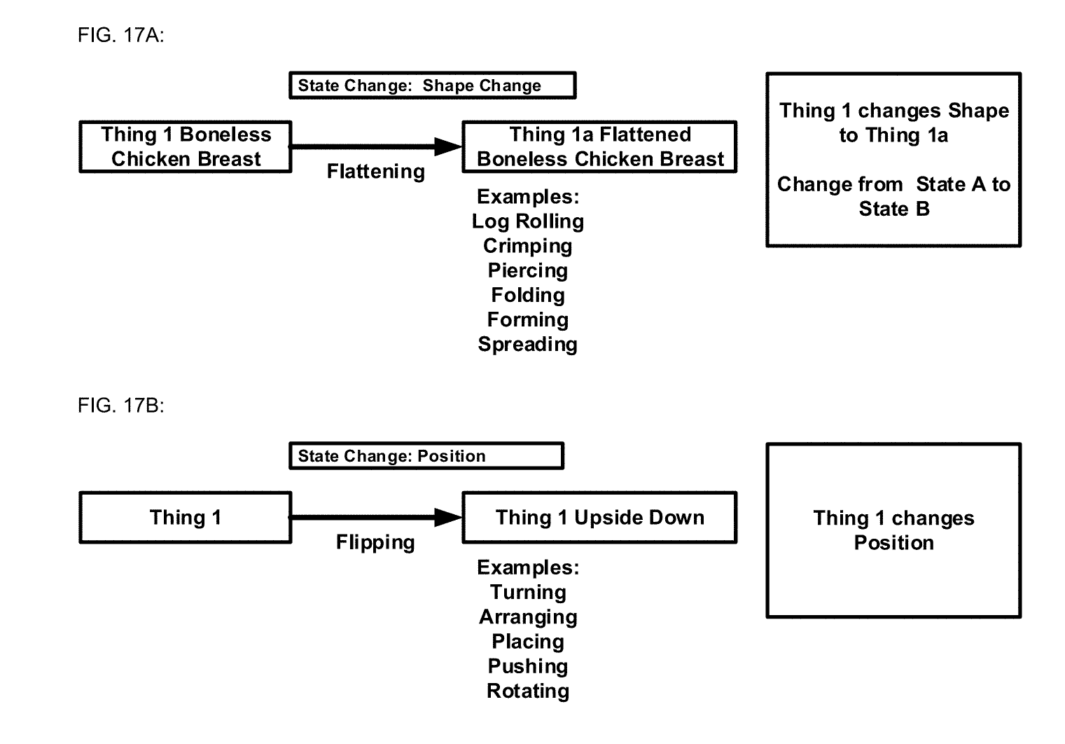

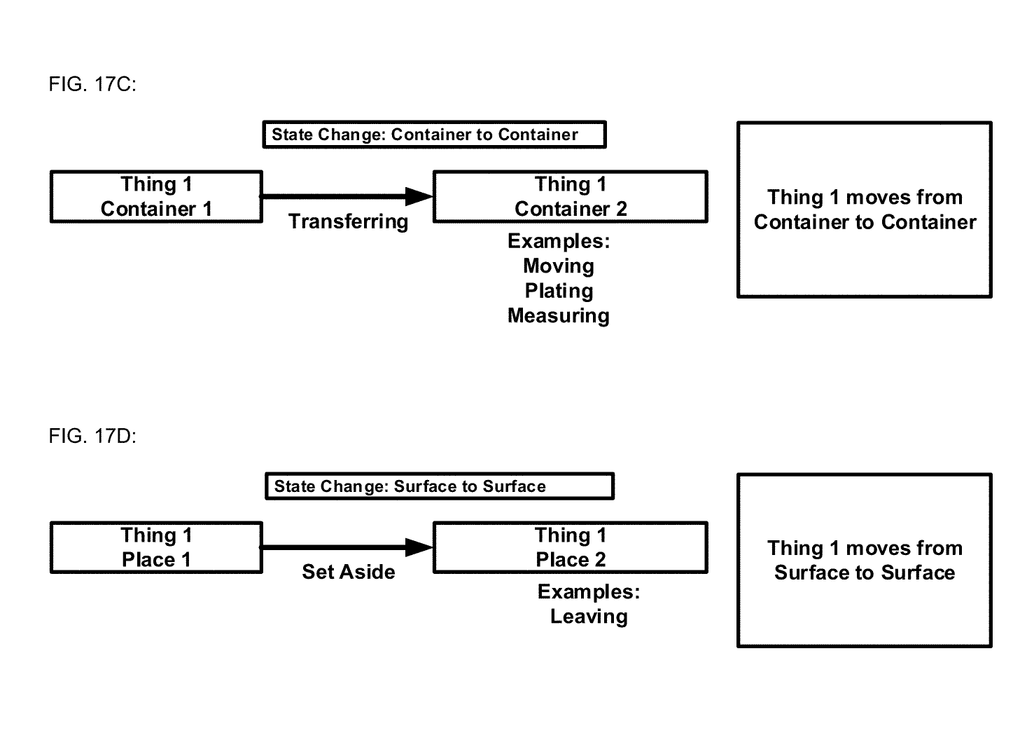

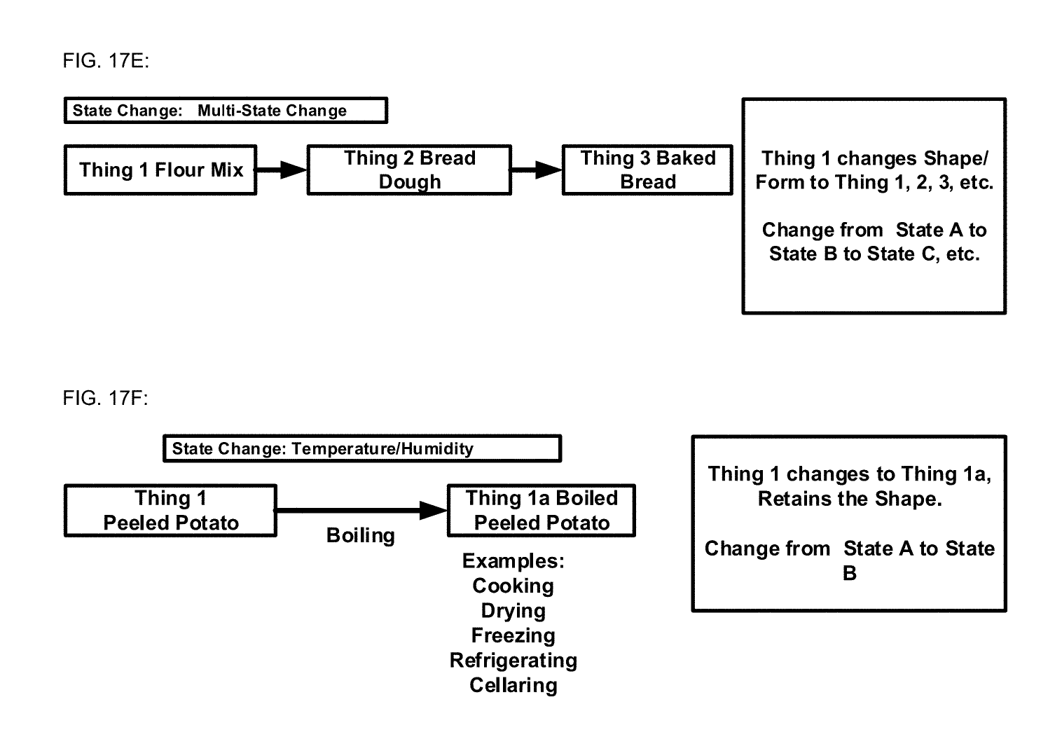

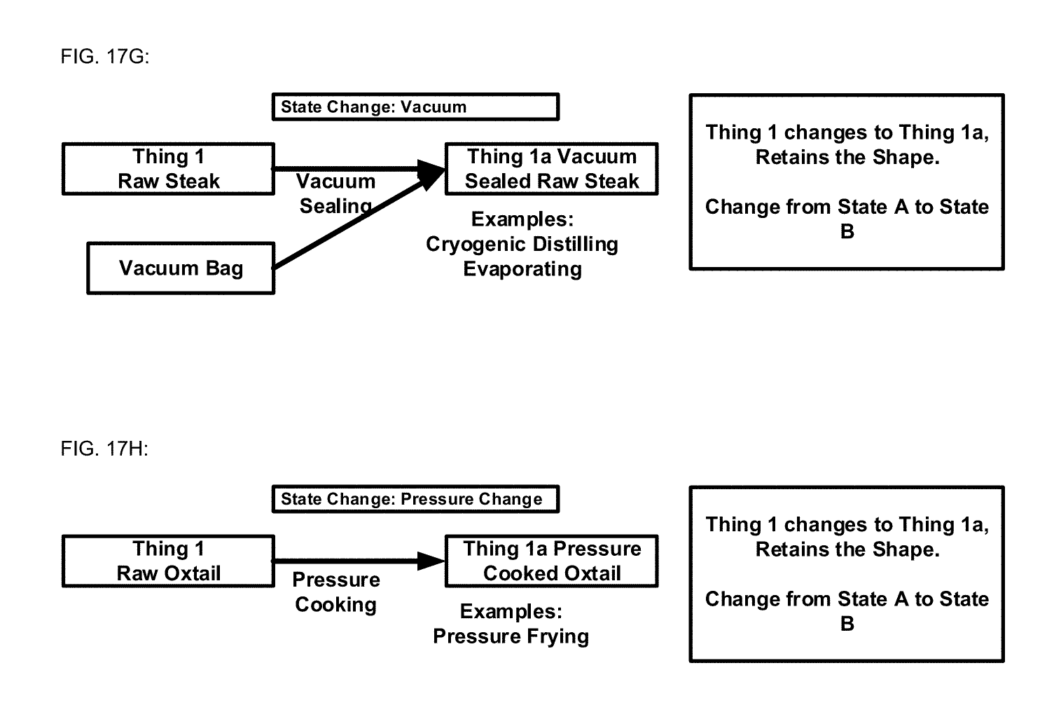

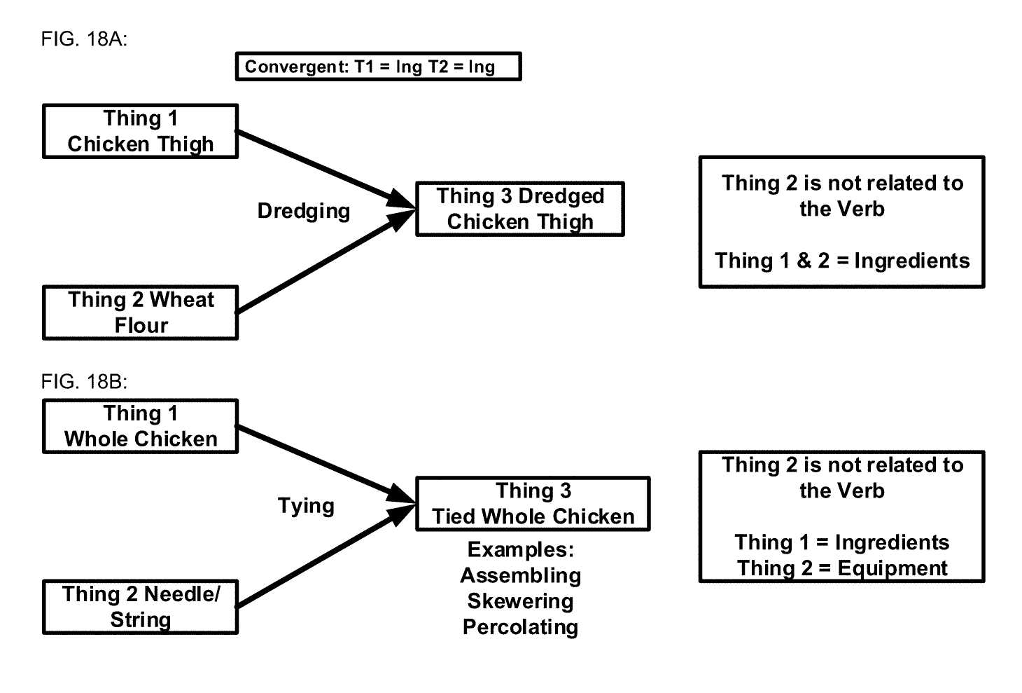

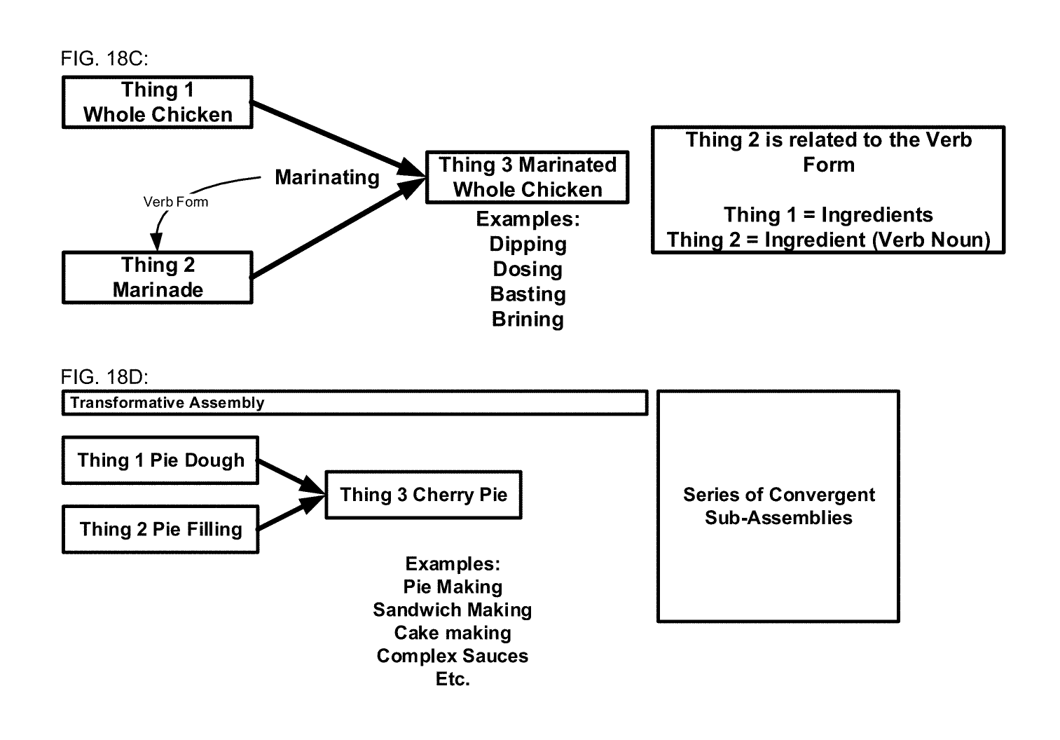

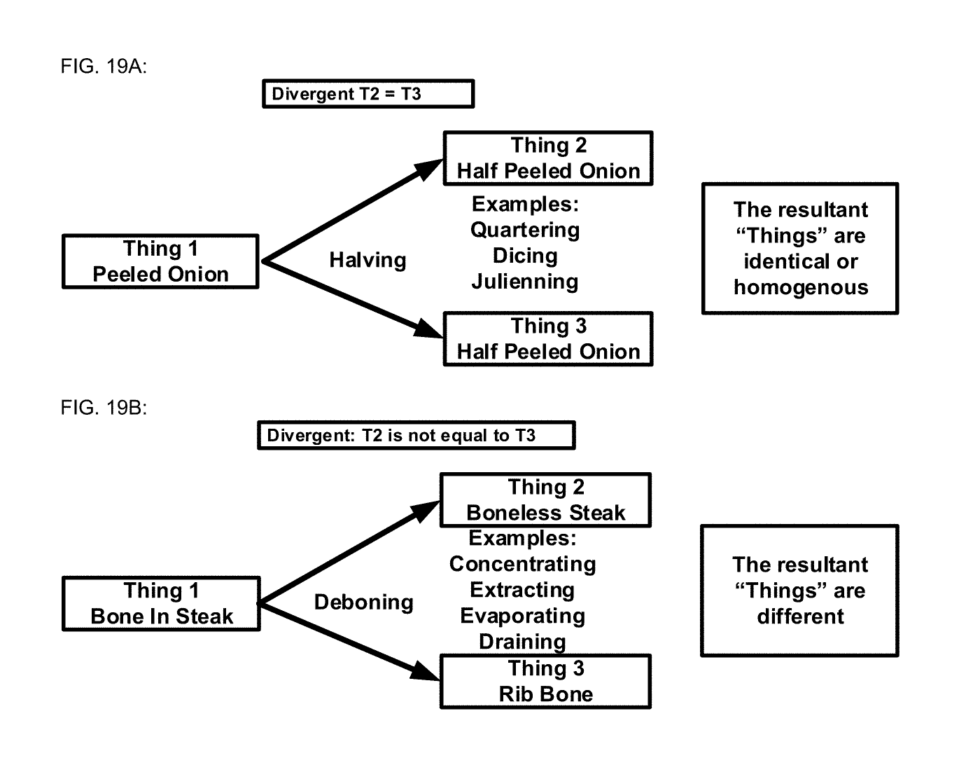

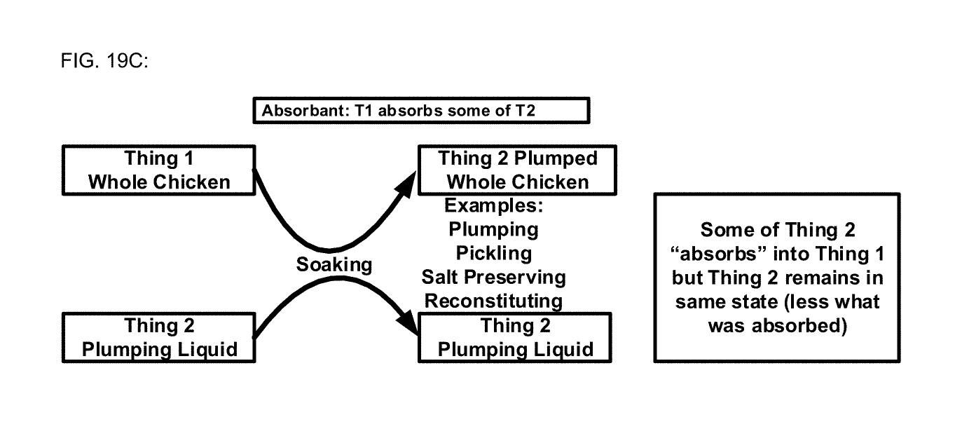

FIGS. 17A-17H schematically illustrate various examples of state change node-to-node structures (e.g., changes of form, position, temperature, humidity, and/or pressure/vacuum) in accordance with certain embodiments described herein. FIGS. 18A-18D schematically illustrate various examples of convergent node-to-node structures in accordance with certain embodiments described herein. FIGS. 19A-19C schematically illustrate various examples of divergent node-to-node structures in accordance with certain embodiments described herein. As used herein, when referring to a thing being “related to the verb form” means that the noun form (e.g., the thing) and the verb form (e.g., the technique) may be based on the same root word and may be placed together, and when referring to a thing being “not related to the verb form” means that the form of the verb (e.g., technique) is not related to the form of either the input noun or the output noun.

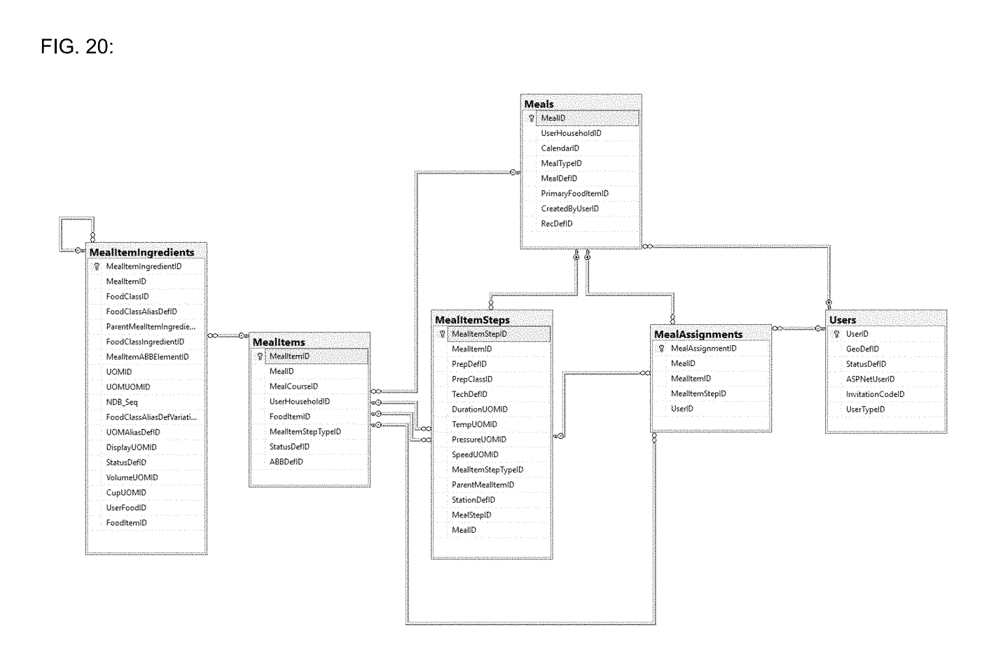

In certain embodiments, the nodes of the node-to-node structure or the one or more node-to-node segments of a recipe, course, or meal can be placed on a calendar or timeline, which can be used to set or coordinate a start time and/or finish time for using the recipe instruction step or steps. FIG. 20 schematically illustrates an example set of database tables that can plot recipes onto a calendar in accordance with certain embodiments described herein. In certain embodiments, the database can subsequently chart action items, their associated ingredients, and the equipment to be utilized on a User's Timeline. The node-to-node structure or segment can use a time duration for each of its techniques. The sum of the individual technique (e.g., step) times can enable the tasks to be scheduled on the timeline or started immediately. The nodes of the node-to-node structure or segment can be placed on a timeline or calendar either sequentially or in parallel to support making or scheduling a particular recipe or set of recipes.

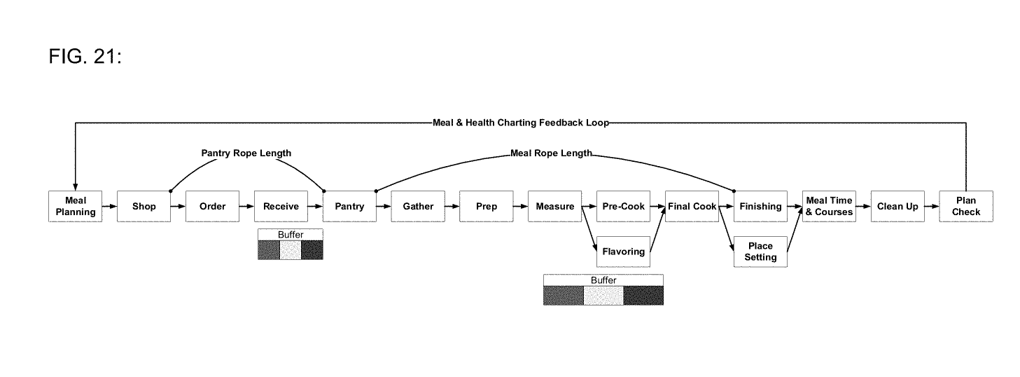

FIG. 21 schematically illustrates an example high level network in accordance with certain embodiments described herein. At a high level, the network can be configured to repeat workflow, where the user can use one or more individual nodes based on how they want to use the software application. As shown in FIG. 21, a meal planning step can be at the highest level that connects with pantry management (e.g., shopping, ordering, receiving, pantry levels). From the pantry, the user can gather the ingredients from the pantry, prep them, measure them, cook and plate them as well as clean up. This network then can loop back to the meal planning.

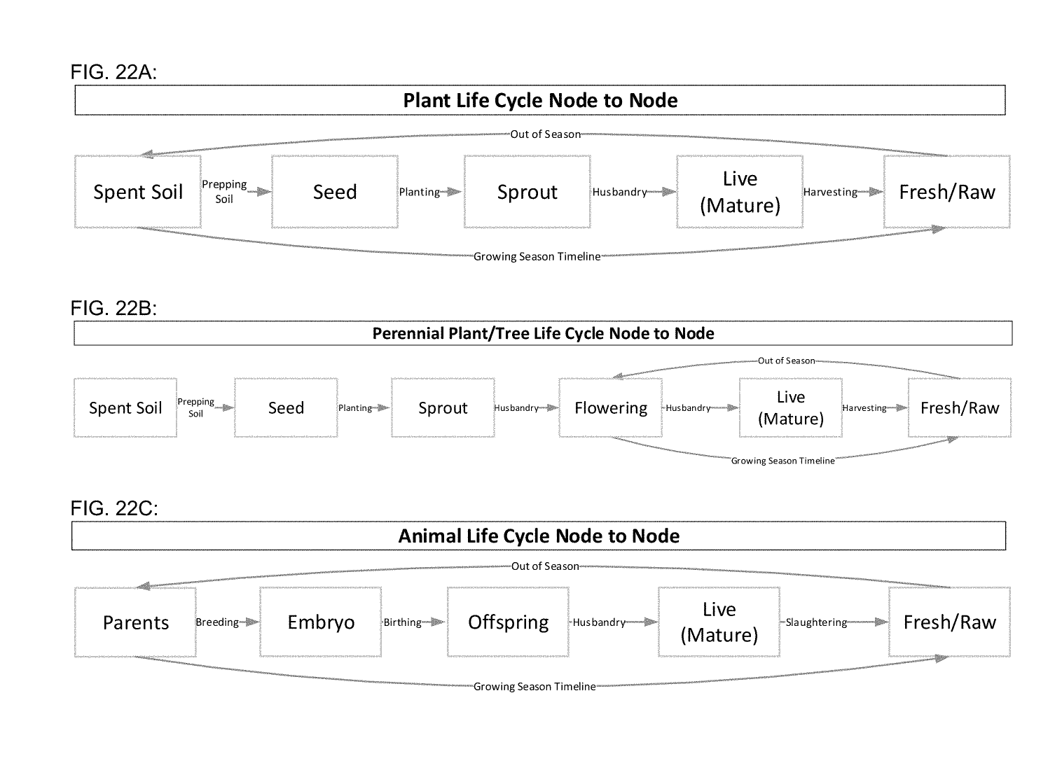

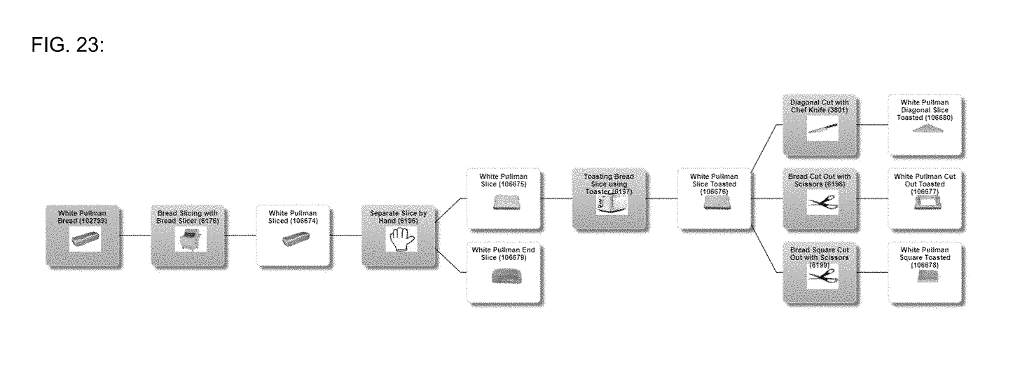

FIG. 22A-22C schematically illustrate the use of the node-to-node structure to model the cycle of life networks and its related seasonality in accordance with certain embodiments described herein. The plants and animals go through life cycles with node milestones, examples of which are shown in FIGS. 22A-22C. For example, FIG. 22A shows an example annual plant cycle, FIG. 22B shows an example perennial plant/tree cycle, and FIG. 22C shows an example animal cycle. The plant and animal life cycle node-to-node structure can show the perpetual growing cycles or regeneration life cycles.

In certain embodiments, the node-to-node structure can be used to tie all the forms and the activities together. The form can be connected via an “Action” to another form. Node A can be connected to Node B by a single verb (e.g., Noun A->Verb->Noun B) or by multiple verbs (e.g., Noun A->Verb1->Verb2, etc.->Noun B), with the verb action(s) changing the state of Noun A to the state of Noun B. FIG. 23 schematically illustrates an example node-to-node structure with forms that can be derived from a loaf of bread in accordance with certain embodiments described herein.

This node-to-node structure can be used throughout the network to standardize and harmonize the techniques and forms. There can be specific networks for cheese, oils, alcohol, baking, and all the cut forms in the food index. In certain embodiments, selected networks model how a product is made and can be kept as a standard. Most variations can be from the ingredient inputs and most food processing can follow the same basic steps with only a few variations (in what is practical).

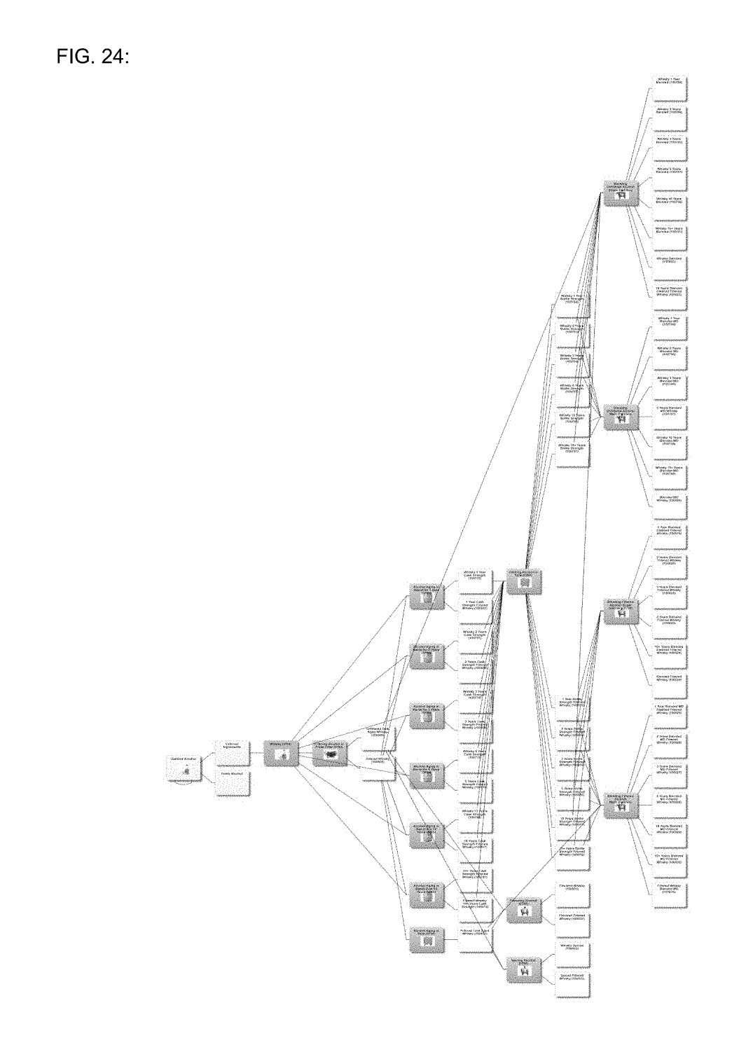

All the recipes can form a web of networks as well. One output of a network can be an input into another network, providing the capability to scroll forward or backward through the network and providing traceability from beginning to end. As shown by FIG. 24, which schematically illustrates the node-to-node structure for Whiskey, the networks can become quite complex.

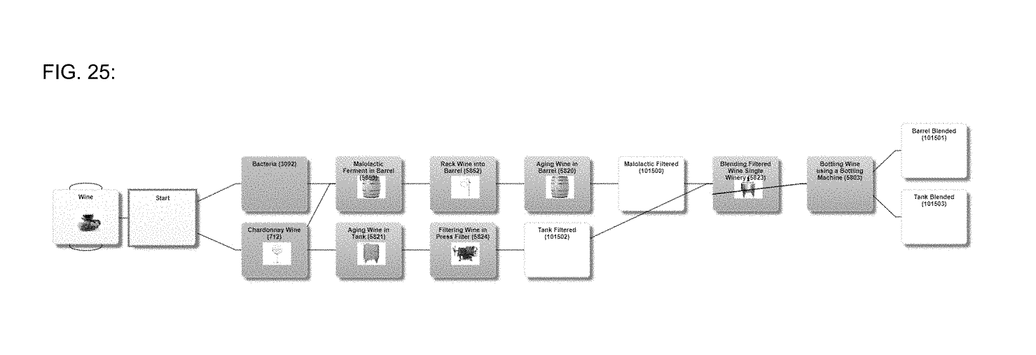

In certain embodiments, all foods can be connected via the node-to-node networks which comprise changes from State A to State B. The connector between A and B is the one or more actions to convert it from A to B, which can be referred to as a node-to-node structure or segment. For example, FIG. 25 schematically illustrates a node-to-node structure for the process industry of fermenting wine (e.g., white wine and variations) in accordance with certain embodiments described herein. As shown by FIG. 25, the ingredients can go through a few steps before a new intermediate product is formed.

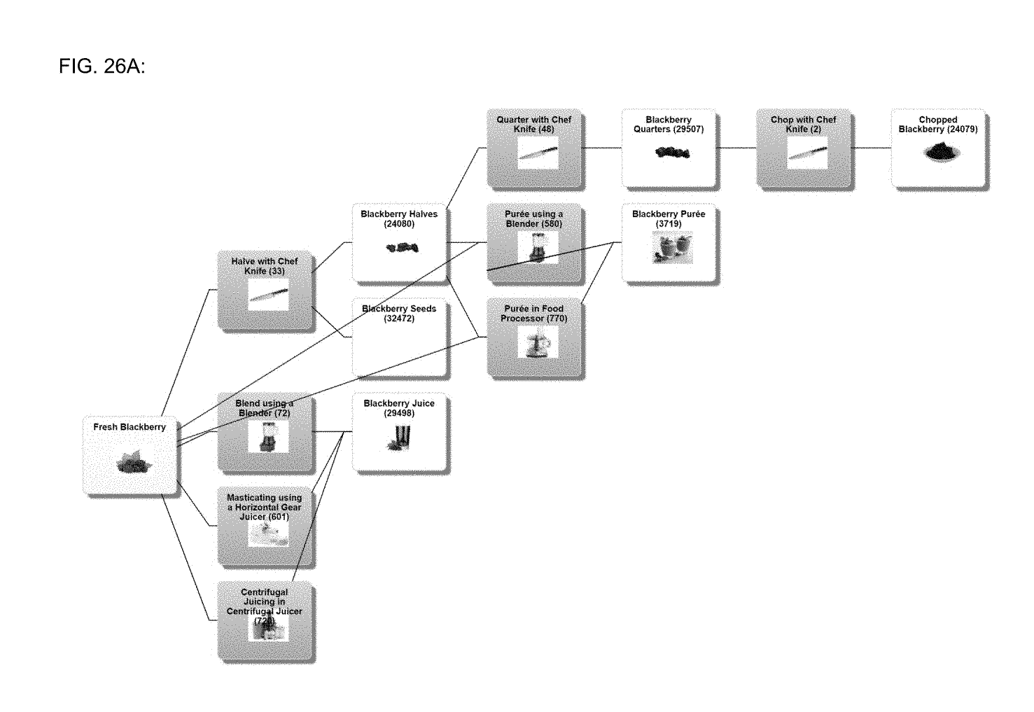

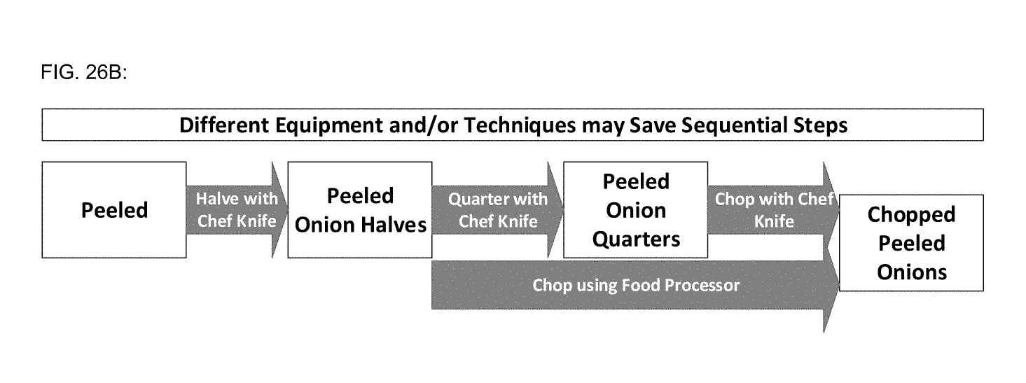

In certain embodiments, there can be more than one way to process an ingredient. FIG. 26A schematically illustrates an example node-to-node structure for Blackberry Juice, in which the blackberries can be made into juice with a Blender, Centrifugal Juicer or with a Masticating Juicer. In certain embodiments, different equipment can skip steps where other types of equipment utilize more steps to be performed. For example, FIG. 26B schematically illustrates an example node-to-node structure for chopped peeled onions in accordance with certain embodiments described herein. A chef knife can be limited to making one slice at a time, with sequential cuts and/or steps, whereas a food processor can directly chop the onion halves, thereby skipping the sequential cutting steps when using a chef knife.

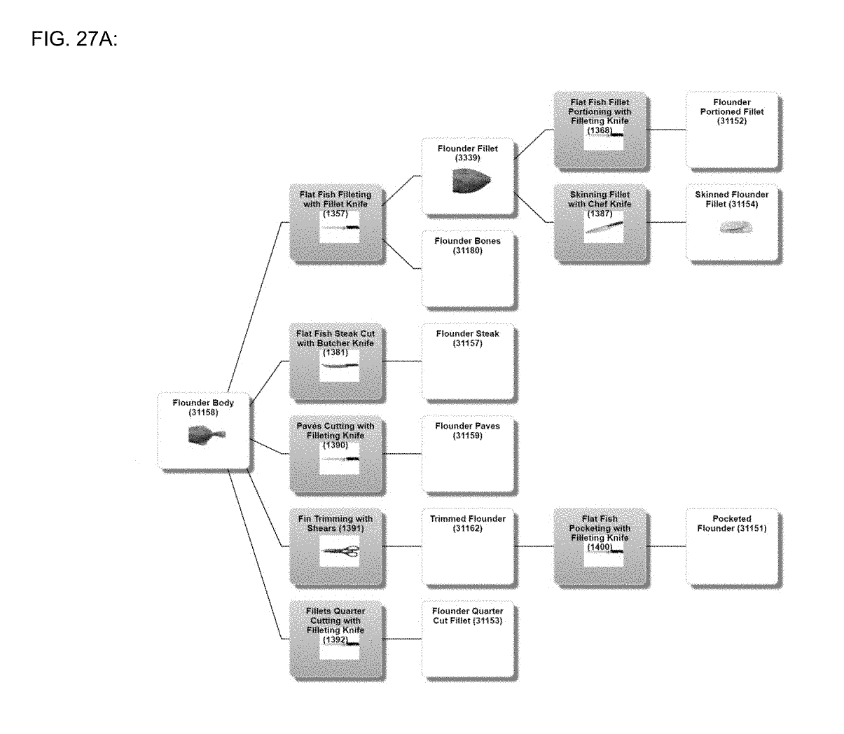

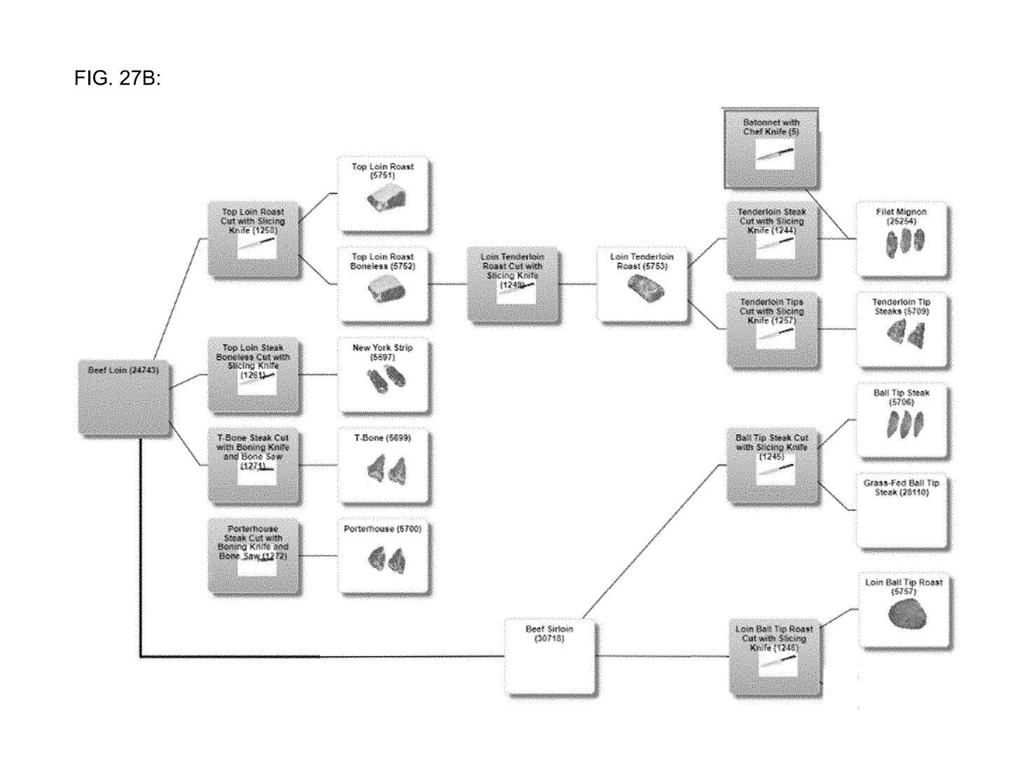

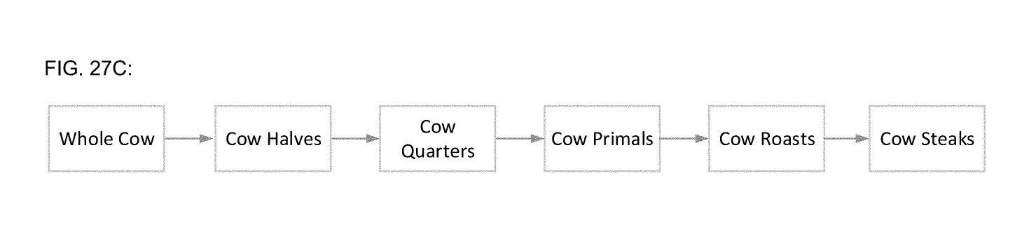

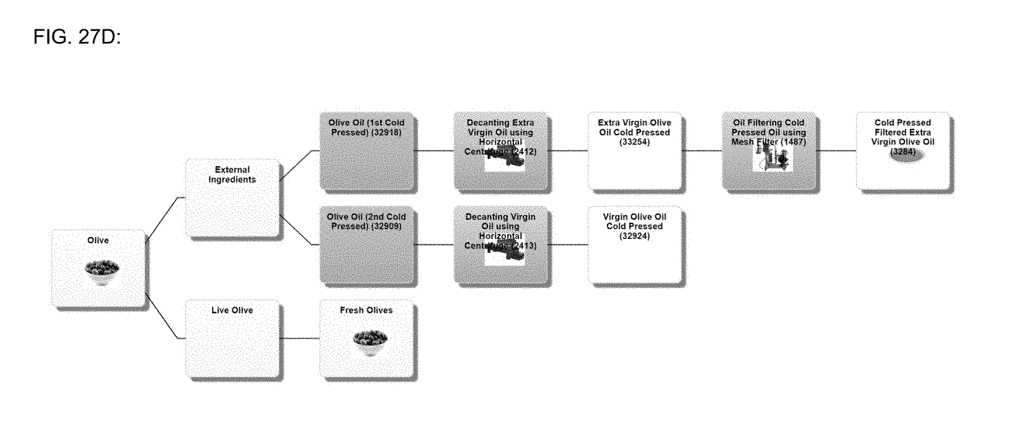

FIG. 27A schematically illustrates another example for a fresh fish cuts network in accordance with certain embodiments described herein, which includes the flounder body and its derivative cuts. FIGS. 27B-27C schematically illustrate another example for a fresh meat cut network in accordance with certain embodiments described herein, which includes the whole cow network for beef. FIG. 27D schematically illustrate another example for a cold-pressed olive oil network in accordance with certain embodiments described herein.

In certain embodiments, the ingredient can be traced backward from a recipe via a modal (e.g., pop-up window) or other visual display which can track the ingredient back to its “Whole Fresh” State. This same process can trace it all the way back through to the vendor. This can be fully connected in the ordering, shipping, and/or pantry management process. The model can utilize the node-to-node structure to trace the steps of how the item was made, starting with its most basic raw material. For example, FIG. 28 schematically illustrates the example for Chopped Garlic in accordance with certain embodiments described herein. As shown in FIG. 28, the node-to-node structure can go step by step back to Fresh Garlic. By accessing the node-to-node structure of the computer database, the user can see all the processing steps for how the garlic was handled.

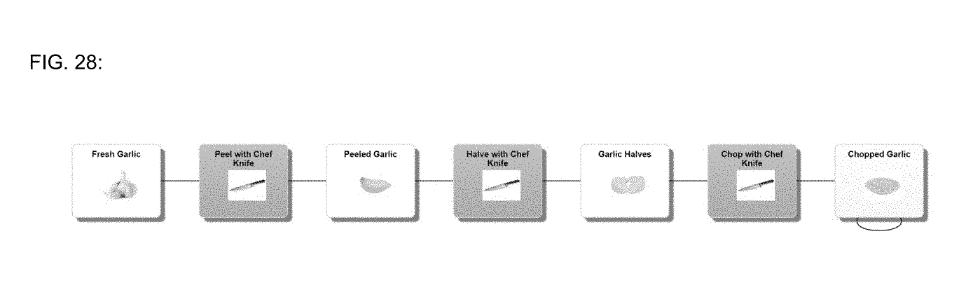

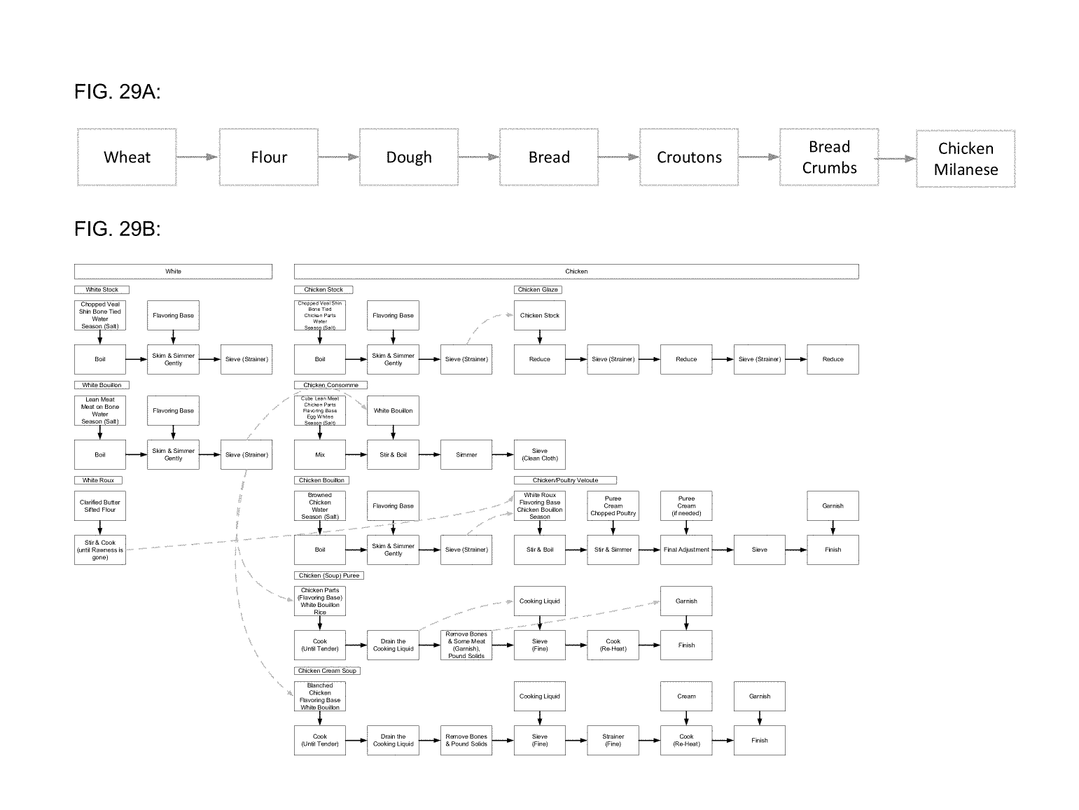

In certain embodiments, a food item can be used as an input into other recipes in complex ways. For example, an item can be an ingredient in a recipe, the result of which may in turn become an ingredient in another recipe, and so on until the end of the chain. FIG. 29A schematically illustrates an example node-to-node network for Wheat in accordance with certain embodiments described herein. As shown in FIG. 29A, wheat can be turned into flour, made into a dough, baked into a bread, toasted into croutons, ground into bread crumbs, which are then used to coat a Chicken Milanese, all of which are shown in the node-to-node structure such that the wheat can be traced back through the chain from the Chicken Milanese. In certain embodiments, the node-to-node structure can connect multiple recipes by calling out the result of one recipe as an ingredient in another recipe. FIG. 29B schematically illustrates an example node-to-node structure (e.g., showing the states without the actions to make each recipe) for a series of traditional French Sauces in accordance with certain embodiments described herein. The French sauces can be included as individual recipes and/or as ingredients into other stocks, broths, or sauces. For example, White Bullion is an ingredient in Chicken Consomme, Chicken Cream Soup, and Chicken Soup; White Roux is an ingredient in Chicken Veloute or Chicken Stock; and Chicken Stock is an ingredient in Chicken Glaze.

In certain embodiments, the node-to-node segments of a recipe network can include the food derivatives and each action of the node-to-node segments can have a time duration and, if appropriate, temperature, speed, and pressure. For example, each node-to-node segment can have a time duration or rate which is dependent on the combination of equipment employed in the technique of the node-to-node segment (e.g., Chopping with a Chef Knife can have one rate, whereas Chopping with a Food Processor can have a different rate). The time of the recipe can be adjusted based on the techniques that are chosen.

In certain embodiments, the node-to-node structure can be used with generic instructions for generating various “how to” actions for multiple food classes, with the generic instruction set up once and then used over and over. For example, the action “Halving with a Chef Knife” is applicable to multiple food classes such as Fresh Fruit/Vegetable/etc., each of which can be cut in half in a standardized manner. The generic instruction of how to halve with a chef knife is the same regardless of the food class (Apple, Pear, Orange, etc.); what changes is the name of the food class, not the technique. In certain such embodiments, the node-to-node structure can be used to generate instructions for different food classes by “substituting” the name of the food class into the same generic instruction (e.g., “Place ‘food class’ on the cutting board and hold with one hand. With the chef knife in the other hand, cut the ‘food class’ in half starting from its stem to produce two equal halves.”).

In certain embodiments, the node-to-node structure can be used to enable call outs of recipes using different techniques/equipment between nodes. For example, a number of different techniques can be used to get from the same node-to-node segment or to the same end result of a node. Multiple techniques can be used with the same starting node and same ending node (e.g., a whole fresh Carrot and be used to make Fresh Carrot Juice by Juicing using a Blender, Juicing using a Centrifugal Juicer, Juicing using a Masticating Juicer, Juicing using a Titurating Juicer, etc.). Multiple techniques can be used with different starting nodes and the same ending node (e.g., Chopped Onions can be produced starting with Peeled Onion Quarters and Chopping with a Chef Knife, starting with Peeled Onions Halves and Chopping with a Food Processor, or starting with Peeled Onions Quarters and Chopping with a Food Processor).

In certain embodiments, each node (e.g., noun in the noun-verb-noun structure) can specify that a unique form of a given food or recipe form. Since each node is unique, then synonyms can be used in order to match ingredients for that particular node. For example, the node-to-node system can include only one instance of Fresh Orange Halves, and can include a number of synonyms for this node including but not limited to: Fresh Orange Halves, Fresh Orange Half, Orange Halves, Orange Half, Half an Orange, etc. In certain embodiments, the node-to-node structure can include various modifiers that can be used to describe the Orange Halves, examples of which include but are not limited to: intrinsic attributes, quantity, size, form, packaging, and process/technique. For example, the modifiers for intrinsic apples can include: Origin, GMO/Non-GMO, Organic, Grade, and Variety (e.g., Origin: California Fresh Orange Halves; GMO: Non-GMO Fresh Orange Halves; Organic: Organic Fresh Orange Halves; Grade: Grade A Fresh Orange Halves; Variety: Valencia Fresh Orange Halves; Size: Large Fresh Orange Halves; Form: Round Fresh Orange Halves; Packaging: Fresh Orange Halves in Clamshell; Process/Technique: Fresh Squeezed Orange Juice). The various modifiers can also be used in a multitude of combinations, and each version of the form can be parsed in order to determine the “Node” in which it belongs.

In certain embodiments, the same node-to-node segment can be used for different parts of other Food Categories or Recipes. Certain such embodiments can advantageously provide standardization by having the same step or series of steps replicated and used in other networks. For example, one can make juice from Fresh Orange Halves. One technique to perform this is Squeezing using an Arm Press Juicer. An example Instruction Set is as follows: “Place a cup under the juice spout and open the spout. Turn on the juicer. Place the <ingredients/> onto the top of the juicing cone and pull down the arm so that the half fits snuggly over and apply gentle pressure. Continue to apply pressure by slowly pressing the arm until the juice is extracted. Continue squeezing the <ingredients/> until the needed amount is obtained.” This same example instruction set (for using an Arm Press Juicer) can also apply to other Fruits in the “Citrus” food grouping which includes, orange, lemon, lime, grapefruit, tangerine, etc. For example, the node-to-node network segment can be created once (e.g., for Oranges), and can then be replicated to all the other food items in the same Citrus Group. This standardization can enable the procedure to be done once and used many times within the node-to-node network. As new techniques/equipment are added, they can be added to the food or recipe node-to-node network by replication. Similarly, for multiple node-to-node segments, other foods/recipes that have the same properties can be grouped together and the node-to-node segment can be replicated into a new segment or can be spliced into an existing network, and can become standards that are easily rolled out to other members of a given food or recipe group. In certain embodiments, this replication can be performed at the network user (e.g., chef) level, while in certain other embodiments, this replication can be performed at the network administrator (e.g., global) level. Parts of the node-to-node network can include a series of verbs (e.g., techniques) which can be re-used or can produce a particular sub-assembly or final assembly. For example, a chef can keep a standard pie crust as a standard, including its related technique of making and forming, and the chef can then vary the pie filling to produce various pies while holding the standard pie crust constant. The same pie crust is then replicated for an apple pie, blueberry pie, marionberry pie, etc.

In certain embodiments, instructions from the node-to-node network can be given as generic descriptions to support the repeating segments. The instruction set can be presented to the user using multi-media, using images, graphics or video. The instructions set can also be used to guide the motions of human movements or robotic movements. As used herein, the term “robotic movements” has its broadest reasonable interpretation, including but not limited to, the action or series of actions performed by a robot or other mechanical or electromechanical device. For example, a robot can be programmed to perform repetitive tasks, techniques, or movements (e.g., pick and place, cutting, sawing, etc.), and once a technique (e.g., movement) is programmed (e.g., learned), then the robot can replicate such movement to be applied in other circumstances. For example, a standard technique (e.g., movement) may be applicable to multiple food classes in the node-to-node network. In certain embodiments, the node-to-node network provides a platform for using these techniques for any other food classes that use the same technique.

In certain embodiments, the node-to-node network groups techniques that are used throughout food preparation into standard “movements” or tasks, which can be used over and over. Alternatively, the robot would have to recognize that the new task is similar to one already programmed, which can be a daunting task since there are an infinite number of combinatorial sequences of techniques (e.g., movements). The robotic movements can be used in conjunction with the node-to-node repeating segments. The movements may be taught by using human motions using light point mirroring, for example. The movements can then be used as a standard node-to-node segment (e.g., instruction, which can then be used with other members of the same node-to-node category. A person or robot can be “certified” in knowing how to perform that node-to-node segment.

Since the node-to-node segments can be standard and repeatable, they can be used to train and set up levels of proficiency, for both human and robotic certification. For example, each node-to-node segment can define a level of proficiency to be obtained. Once obtained, then all the other foods/recipes that use the same node-to-node segment can also fall under the qualification. A person or a robot could be certified to perform a given node-to-node segment, and they then would qualify for all the other food/recipes that also have that same node-to-node segment. For example, a person or robot could be certified to be proficient with the Chef Knife to cut particular items in Half. If they can cut Oranges in Half, then they would be qualified to cut limes, lemons, tangerines, etc. in half as well. A person or robot could build up proficiencies to perform basic tasks that then build upon one another to perform more and more complex tasks. They start to gain proficiency in more and more parts of the food and recipe segments.

In certain embodiments, the node-to-node system is configured to enable a person or robot to master different techniques/equipment along with a means to track these activities and proficiencies. Certain such embodiments can advantageously provide a systematic method to train and certify the person or robot to have proficiency on individual parts of the total network. In contrast, prior methods perform training on one-offs, which is time consuming and redundant. In certain embodiments, the library of techniques along with their generic segments as described herein can create a set of standards that can be used to teach humans or robots and track their proficiencies or skill sets.

In certain embodiments, the node-to-node structure can be applied to other uses, e.g., food equipment repair, watch repair, phone repair, etc. These applications can utilize an item to be disassembled, the broken item removed and replaced, and then the item is reassembled. The disassembly can be a divergent network which creates many parts as the whole item is disassembled. The broken item is replaced, then the procedure can be done in reverse to re-assemble the item back into one piece. A total divergent network can be defined where all the parts can be disassembled into their component parts. Once the divergent network is defined, then all replacements of defective/broken parts can follow the divergent network, disassembling the requisite parts and replacing the defective parts. The item can then be reassembled by “flipping” the path in the divergent network the opposite way to create a convergent network. The items can then be reassembled following the network node by node until it converges back into the original item. Various devices (e.g., watches; cellular phones) that can be taken apart and either repaired or replaced can be follow this mirrored network (divergent back to convergent).

In certain embodiments, recipes can be dynamically generated (e.g., generated in real-time) using the node-to-node structure in various ways: (i) based on the status, state/form, or temperature of food/ingredients and their related quantity in the pantry, (ii) based on the equipment on hand in the kitchen at any given time, and/or (iii) based on the given skill set at the moment of the user/robot at time of recipe generation. These dynamic generation techniques can be used individually (e.g., one at a time), or in combination with one another.

With regard to the status, state/form, or temperature of food/ingredients in the pantry, the node-to-node network can enable the dynamic (e.g., real-time) generation of recipes based on the quantity of food items or ingredients on hand at the moment of generation. The pantry can change in real time with food items being withdrawn and replenished. When a recipe is generated, the system can use the node-to-node network to determine the state, temperature, and quantity of each ingredient available to be used for the recipe. This can affect the nodes (e.g., ingredients) to be used as the starting points of the recipe and what actions are used during the recipe (e.g., the actions used to prepare the ingredients for the recipe). The starting points can determine the series of steps and the corresponding times to prepare, measure, or otherwise have the food items ready for the recipe. For example, if one day, the user has chopped onions in their refrigerator (e.g., pantry), and chopped onions are required for the recipe, then the only prep time for the chopped onions is the gathering time to get it ready for the recipe. If the next time the recipe is used, there is only fresh (whole) onions, then in addition to the gather time, the prep time for the recipe can include the time for changing the fresh onion into chopped onions. For another example, the item could be fresh or frozen, and the prep time using the frozen item would include time to thaw, where the prep time for using the fresh item would not.

With regard to the equipment on hand, the node-to-node network can enable the dynamic (e.g., real-time) generation of recipes based on the kitchen equipment available to make the particular recipe. For example, the recipe may call out a food processor to make a given recipe one day. If on another day, the food processor is broken and no longer available, then a substitute equipment, like a chef knife would be called out. The time and steps utilized by the user to prepare a given set of ingredients with a chef knife would be different than that for a food processor.

With regard to the skills or proficiency of a given user or robot, the node-to-node network can enable dynamic (e.g., real-time) generation of recipes based on the techniques/equipment that the user has proficiency to use. For example, if the user has a food processor, but doesn't have the proficiency to use it, then the recipe would call out the technique that the user can use to make the recipe. The household members can each have different skill sets, which can be specified in the system. If for example, a child of 8 years old may not be allowed to carry out preparation steps utilizing knives, but can be skilled in gathering food items. The node-to-node system can task the child for the food gathering steps (e.g., guided step by step via the node-to-node system) for the items to be pulled from the pantry based on a pick list generated by the system. Household members or robots can be certified to carry out given node-to-node segments (e.g., main steps like gathering, prepping, specific techniques, or to operate or not operate specific kitchen equipment).

In certain embodiments, the node-to-node system supports integrating the calculating of item counts, weights, and volumes in the dynamically-generated recipes. As an example of the node-to-node network supporting item counts, an apple can produce 2 halves or 4 quarters. The recipe can call out 4 quarters, so the system knows that one apple is to be used. If the number of servings is changed on a recipe, then the system can connect the item counts based on the ingredients or the fresh, raw or live form. As an example of the node-to-node network supporting weights in which the system convert the weights from one disparate item to another, if 4 hamburger patties are to be used and each patty serving is ¼ lb., then the system knows that one pound of ground beef is to be used or one pound of top sirloin steak is to be ground into one pound of ground beef and formed into 4 quarter pound patties. As an example of the node-to-node network supporting volumes, the system can add up the volume of ingredients and present it either in terms of volume or convert it to weight and/or can use the volume to calculate the size of the containers that are to be used for a given recipe. For example, if the volume is 1 quart, then the system knows that only containers that are 1 quart or larger can be used for the recipe. Certain recipes can specify that the volume fills only a certain percentage of a container. For example, boiling pasta can use 4 quarts of water and 1½ tablespoons of Kosher Salt for each pound of pasta. However, the container can only be 2 thirds full, to avoid spilling the boiling water when the pasta is added. Therefore, the container can be specified to be 6 quarts or larger for each pound of pasta called out in the recipe. The user can specify the volume sizes of their containers and the specific container matching the recipe can be called out based on the volume requirements of the recipe.

In certain embodiments, variants of a node pair have the same starting and ending nodes as one another. Among the variants of a node pair, State A and State B are constant, but there are a multiplicity of methods/techniques that convert State A to State B. One variant can be set as a standard. The standard is then compared to the multiplicity of other methods/techniques, equipment or ingredients of converting something from State A to State B. In certain embodiments, a comparison can be made of a multiplicity of variants to the standard. Other variants are easily created using the standard and then varying one or more elements of the method/technique, equipment or ingredients. In certain embodiments, the node-to-node structure also enables node pairs or a series of nodes be used for other recipes, which, in certain embodiments, can provide a building block approach to building recipes.

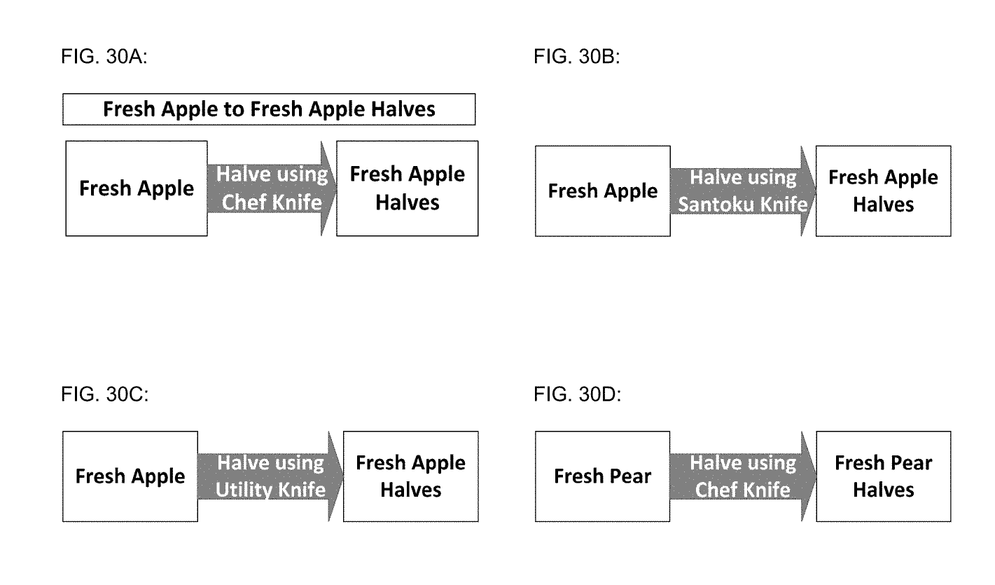

For example, FIG. 30A schematically illustrates an example node pair for halving a fresh apple in accordance with certain embodiments described herein. The example node pair of FIG. 30A can use a Chef Knife and can have multiple method/technique variations, one of which is a standard method/technique and others of which are multiple variant methods/techniques. For example, the standard method/technique can be: “Place the apple onto the cutting board with the stem side on top. Slice the Apple with the Chef Knife starting at the stem and cut straight down to produce two equal halves.” A first variant can be: “Place the apple onto the cutting board with the stem side on bottom. Slice the Apple with the Chef Knife starting at the middle of the bottom and cut straight down to produce two equal halves.” A second variant can be: “Place the apple onto the cutting board with the stem side on top. Slice the Apple with the Chef Knife holding the knife at a 45 degree angle. Start at the stem and cut downward to produce two equal halves.”

Equipment can comprise tools, containers, appliances, work/cooking surfaces among many other items, which can be the basis for other variants (e.g., based on individual equipment variants or based on paired sets of equipment). For example, a knife can be paired with a cutting board. Chopped onions can be chopped with a knife and cutting board combination or a variant could be chopping with a food chopper on a work surface or a food processor on a work surface. The variants can be individual pieces and/or paired pieces of equipment.

FIGS. 30B-30C schematically illustrate example node pairs for halving a fresh apple, with equipment variation from that of FIG. 30A, in accordance with certain embodiments described herein. The example node pair of FIG. 30A which uses a Chef Knife can be considered to be the standard method/technique: “Place the apple onto the cutting board with the stem side on top. Slice the Apple with the Chef Knife starting at the stem and cut straight down to produce two equal halves.” The example node pair of FIG. 30B which uses a Santoku Knife can be considered to be a first variant: “Place the apple onto the cutting board with the stem side on top. Slice the Apple with the Santoku Knife starting at the stem and cut straight down to produce two equal halves.” The example node pair of FIG. 30C which uses a Utility Knife can be considered to be a second variant: “Place the apple onto the cutting board with the stem side on top. Slice the Apple with the Utility Knife starting at the stem and cut straight down to produce two equal halves.”

FIG. 30D schematically illustrates an example node pair for halving a fruit, with ingredient variation from that of FIG. 30A, in accordance with certain embodiments described herein. The example node pair of FIG. 30A halves a fresh apple, and can be considered to be the standard: “Place the apple onto the cutting board with the stem side on top. Slice the Apple with the Chef Knife starting at the stem and cut straight down to produce two equal halves.” The example node pair of FIG. 30D halves a fresh pear, and can be considered to be a first variant: “Place the pear onto the cutting board with the stem side on top. Slice the Pear with the Chef Knife starting at the stem and cut straight down to produce two equal halves.”

In certain embodiments, there can be multi-element variants corresponding to a standard node-to-node conversion, such that the instruction set of a node-to-node conversion can have a multiplicity of variants that are handled by one standard instruction set. Text can be used in conjunction with the node-to-node system to provide specific valid variants to fill in the general categories (e.g., indicated by <category/>) and/or to utilize variations in the ingredient(s), technique, surface (cooking), container, and tools and to generate recipe directions provided to the user, e.g.:
With the <surface/> at medium heat. Place the <container/> on the heated surface and wait until it reaches temperature. Add in the <ingredient1/> and bring to temperature. Add the <ingredients2/> and cook the food quickly by <technique/> them using the <tool/> to cook them evenly. Continue until they are softened.
   with variants of the surface including Gas Range, Electric Range, Induction Range, etc.; variants of the container including Saute Pan, Fry Pan, Grill Pan, Omelet Pan, etc.; variants of the tool including Spoon, Spatula, Slotted Spoon, etc.; variants of the technique including Flipping, Tossing, etc.; variants of ingredients1 including Butter, Vegetable Oil, Lard, Canola Oil, Olive Oil, etc.; and variants of ingredients2 including Onions, Garlic, Carrots, Celery, etc.

In certain embodiments, the node to node system, by utilizing a standard and variants between two nodes, advantageously allows the two nodes to be used as a basis for generating multiple versions of the recipe instruction set (e.g., to be used in various recipes) in which one, two, or more of the elements are held constant while one, two, or more of the elements are varied, e.g.:
The equipment is held constant while either the ingredients and/or the method/technique is varied.
The ingredient is held constant while either the equipment and/or the method/technique is varied.
The technique/method is held constant while either the ingredients and/or the equipment is varied.

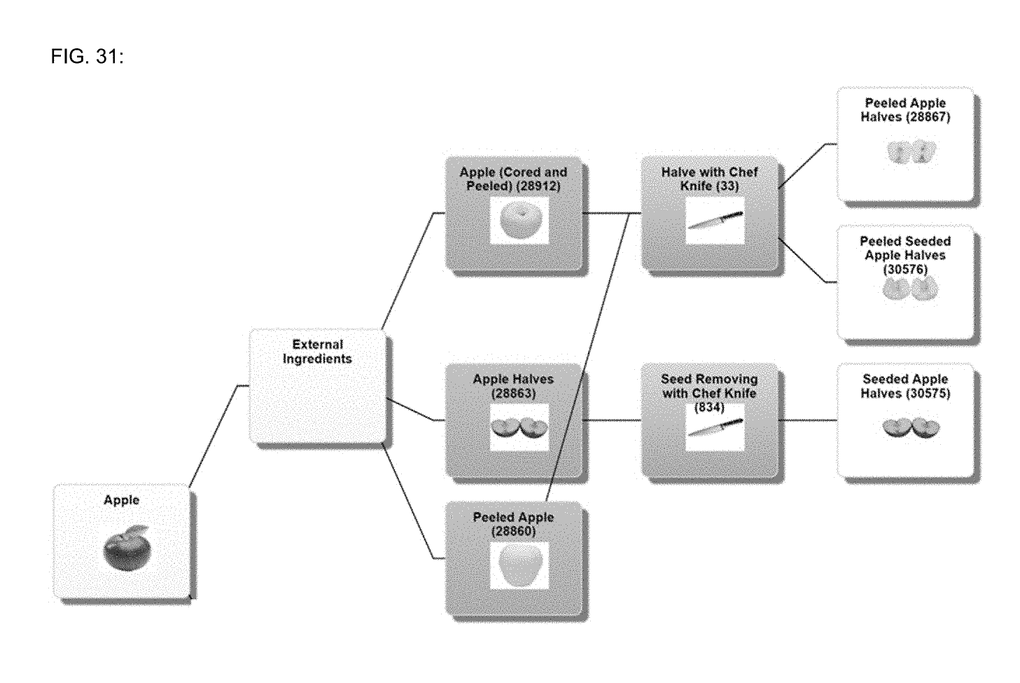

In certain embodiments, the starting point node of a particular node-to-node network (e.g., a V-Network) is a given node corresponding to a particular element (e.g., ingredient). For example, FIG. 31 schematically illustrates an example node-to-node V-network for a Fresh Apple in accordance with certain embodiments described herein. The Fresh Apple is connected to all the derivative apple forms in its node-to-node network. The derivative forms can then be used as the inputs into a multiplicity of recipes where the fresh apple is used in its various forms.

In certain embodiments, the starting point node of a node-to-node network can be used to provide to the user (e.g., display to the user) a list of potential recipes that may be performed using the starting point node. For example, by having the same starting point node, one question (e.g., user-generated food-related query) that can be answered using the node-to-node network is: “What can I make with a Fresh Apple?” In answering this question posed by a user, the node-to-node network can be used to show a multitude of recipes which use a Fresh Apple via its multiplicity of Forms, (Halves, Seeded Halves, Peeled Halves, Peeled & Seeded Halves, Quarters, Seeded Quarters, Peeled Quarters, Peeled & Seeded Quarters, Slices, Seeded Slices, Peeled Slices, Peeled & Seeded Slices).

In certain embodiments, other nodes of the node-to-node network can be used to provide the user with a list of potential recipes that may be performed using the particular node. For example, using the node corresponding to Apple Form: Peeled & Seeded Slices, the node-to-node network can be used to provide the user (e.g., display to the user) with a multitude of recipes using this one form. Certain such embodiments advantageously enable a user to see the multiplicity of recipes from the perspective of any node within the node-to-node system.

As another example, a node-to-node network can connect a multiplicity of forms for the Loaf of Bread: Sliced Loaf, End Pieces, Slices, Loaf Halves, Loaf Sections, ¾ cut Loaf, Croutons, Bread Crumbs, etc. Using the node-to-node network, the Loaf of Bread can be connected to all the derivative forms in its network. The forms are then the inputs into a multiplicity of recipes where it is used in its various forms, and these recipes can be accessed in response to queries posed by the user. For example, the query “What can I make with a Loaf of Bread?” can be answered by providing (e.g., displaying to) the user with a multitude of recipes which use a Loaf of Bread via its multiplicity of forms, (e.g., Sliced Loaf, End Pieces, Slices, Loaf Halves, Loaf Sections, ¾ cut Loaf, Croutons, Bread Crumbs, etc.).

In certain embodiments, the system comprises a standard node-to-node network (e.g., V-Network) corresponding to a particular ingredient, in which the various forms of the ingredient are connected to one another, and the standard node-to-node network is used for other, different ingredients as well. For example, the system can comprise a standard node-to-node network corresponding to a fresh apple, connecting the various forms of the fresh apple to one another, and this node-to-node network can be used with (e.g., shared by) a fresh pear or other similar fruits. While apples and pears are slightly different shapes, they have the same characteristics in the methods, techniques, and equipment and the same derivative forms. For example, both apples and pears can be used in substantially the same forms, e.g., Halves, Seeded Halves, Peeled Halves, Peeled & Seeded Halves, Quarters, Seeded Quarters, Peeled Quarters, Peeled & Seeded Quarters, Slices, Seeded Slices, Peeled Slices, Peeled & Seeded Slices.

In certain embodiments, the node-to-node system advantageously enables a first node-to-node network (e.g., a standard network; a V-Network) to be created for one ingredient/food class (e.g., “apples”), and then the node-to-node network can be replicated as a second node-to-node network for another ingredient/food class (e.g., “pears”). The second network shares the same standards and variants between the nodes as does the first network. For another example, Pan Bread is the rectangular shaped, square cross-section bread that takes its form from a rectangular baking pan or Pullman baking pan. The Pan Bread network and its derivatives are all the same regardless of the particular variant of the bread (e.g., whether the bread is white, whole wheat, whole grain, 7 grain, 12 grain, sourdough, country potato, etc.). The derivative forms of Pan Bread can include, Whole Loaf, Sliced Loaf, End Piece, Slice, Halved Loaf, etc. The Pan Bread network can be replicated for any of the variants of the Pan Bread Loaf (e.g., such as white, whole wheat, whole grain, 7 grain, 12 grain, sourdough, country potato, etc.). The Pan Bread network also can share the same method/technique and equipment variants between the nodes.

In certain embodiments, the node-to-node system comprises general or generic node-to-node networks (e.g., V-networks) that apply to multiple ingredients, and such a generic node-to-node network is used as a standard (e.g., generic) network where a multiplicity of Food or Recipe Types use the identical network. For example, the Apple, Pear, and Quince are similar fruits of the Pome group, and the system can comprise a node-to-node network generically known as the Pome Network. For another example, the Pan Bread network can be considered to be a generic node-to-node network that applies to the multiplicity of breads made in a rectangular baking pan or a Pullman baking pan. Other bread networks can include the Baguette Network, the Round Bread Network, the Loaf Network, the Petit Loaf Network, 3 Braided Bread Network, 4 Braided Bread Network, etc.

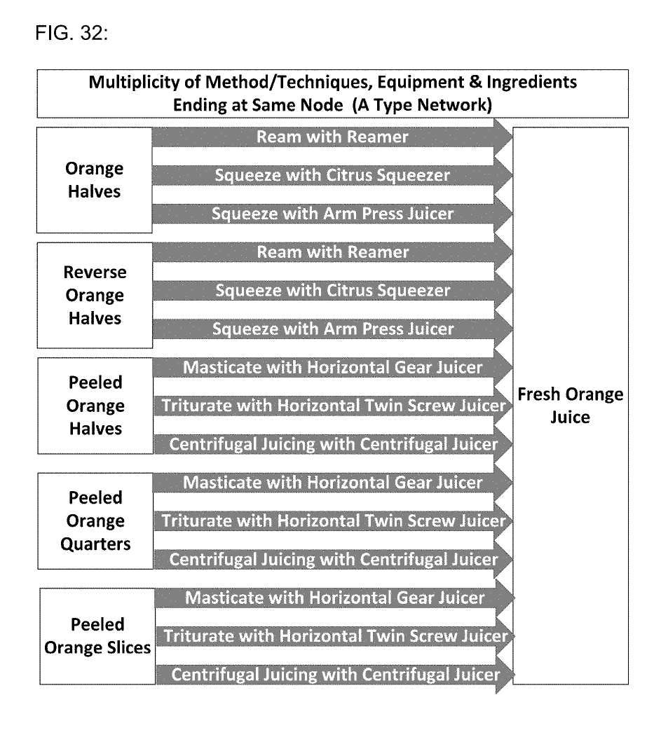

In certain embodiments, when the ending node is specified, there can be one or more node-to-node network segments that produce the same end node state (e.g., an A-Network). For example, FIG. 32 schematically illustrates an example node-to-node network (e.g., A-network) for orange juice in accordance with certain embodiments described herein. The end node of FIG. 32 is Fresh Orange Juice, and there is a multiplicity of equipment, ingredient forms, and method/techniques that can be employed to produce the Fresh Orange Juice. In certain embodiments, the node-to-node system utilizes one or more A-Networks to advantageously allow the two nodes to be used as a basis for generating multiple versions of the recipe instruction set (e.g., to be used in various recipes) in which one, two, or more of the elements are held constant while one, two, or more of the elements are varied. For example, the end node can be held constant while either the ingredients forms, the method/technique, and/or the equipment is varied. For another example, a user specifying their technique/methods can be shown recipes that are available using such technique/method. For still another example, a user specifying their equipment can be shown recipes that are available using such equipment.

In certain embodiments, the node-to-node system can advantageously be used to instruct a user (e.g., beginner user) via the methods and/or techniques of an A-Network, or to present the user with recipes utilizing a network segment previously learned by the user, as well as alternative network segments that are related to the network segment previously learned by the user. For example, if the beginner has learned to Halve an Apple with a Chef Knife, then they would also be proficient in using the same technique with a Santoku Knife or a Utility Knife, and the system could replicate the learned network segment, modified to include the changed tool, to present the user with recipes utilizing such alternative network segments. If the beginner has learned to Halve an Apple with a Chef Knife, then they would also be proficient in halving a Pear or Quince using the same technique, and the system could replicate the learned network segment, modified to include the changed ingredient, to present the user with recipes utilizing such alternative network segments. If the beginner has learned to Slice White Pan Bread with a Bread Knife, then they would also be proficient in using the same technique and Bread Knife to slice pan bread of whole wheat, whole grain, 7 grain, 12 grain, sourdough, country potato, etc., and the system can replicate the learned network segment, modified to include the changed ingredient, to present the user with recipes utilizing such alternative network segments. If the beginner has learned to Slice White Pan Bread with a Bread Knife, then they would also be proficient in using the same technique and a Utility Knife to slice pan bread of white, whole wheat, whole grain, 7 grain, 12 grain, sourdough, country potato, etc., and the system could replicate the learned network segment, modified to include the changed tool and/or ingredient, to present the user with recipes utilizing such alternative network segments.

In certain embodiments, the node-to-node system can advantageously be used to instruct (e.g., program) a robot to carry out recipes utilizing network segments that are related to a previously programmed network segment. For example, if the robot has been previously programmed to Slice White Pan Bread with a Bread Knife, then it would also be proficient in using the same technique and Bread Knife to perform alternative network segments such as to slice pan bread of whole wheat, whole grain, 7 grain, 12 grain, sourdough, country potato, etc., and the system can replicate the programmed network segment, modified to include the changed tool, to program the robot to carry out recipes utilizing these alternative network segments. If the robot has been previously programmed to Slice White Pan Bread with a Bread Knife, then it would also be proficient in using the same technique and a Utility Knife to perform alternative network segments such as to slice pan bread of white, whole wheat, whole grain, 7 grain, 12 grain, sourdough, country potato, etc., and the system can replicate the programmed network segment, modified to include the changed tool and/or ingredient, to program the robot to carry out recipes utilizing these alternative network segments.

In certain embodiments, the node-to-node network can advantageously use its replicated network segments to track the proficiency of chefs and robots. As skills are acquired (e.g., mastered by the user or programmed into the robot), then proficiency in using a given set of ingredients, ingredient groups, equipment, and/or methods/techniques within given sections of the node-to-node network can be tracked. As these skills are acquired, then the network segments and alternative network segments can be used to select (e.g., parse) recipes or preparations which are to be presented to the user (e.g., chef) or the robot. A robot may be used, for example, to prep vegetables (e.g., one Vegetable network at a time), as the robot gains proficiency in prepping vegetable networks, then it is able to change vegetables from State A to State B to State C, etc. The use of standard network segments or their variants can be used to show a multiplicity of recipes or their sub-sections that are to be carried out by the user or the robot.

In certain embodiments, the node-to-node system can advantageously record (e.g., track; trace) which network segments are known by a chef or robot, thereby enabling the node-to-node system to delegate particular network segments to a given resource (e.g., user of a plurality of users; chef; robot) that has proficiency in those network segments. In certain embodiments, the node-to-node system advantageously shows and/or selects a multiplicity of recipes based on the proficiency of the chef(s) and/or robot(s) participating in the preparation, cooking or other tasks of the recipe and/or its courses, and/or the meal.

In certain embodiments, a recipe can be considered to be either a single recipe or a multiplicity of recipes. An example challenge for someone writing a recipe is to what level of specificity the writer should call out to explain when writing a recipe. For example, if the recipe calls out Chopped Onion, does the recipe writer need to explain how to chop onions? For another example, if the recipe calls out a Toasted White Bread Slice, does the recipe writer need to explain how to toast a slice of white bread? Expressed differently, this example challenge for writing recipes can be considered to be knowing what is the starting point to prepare each ingredient and to what level of detail is required to explain the recipe to the user. This level of detail also varies depending on the level of skill of the person that the recipe is written for. A beginner may need more detailed explanation than that of a professional chef. The recipe writer then generally decides who the audience is for the recipe when writing it. If they put in too much detail, the professional chefs will balk. If the concepts are too advanced, then a beginner will be lost.

Using conventional systems, standards for recipes are very difficult to create or utilize, since the starting point of the recipe depends on the audience that the recipe writer is trying to explain. The starting point is also dependent on the starting state of the ingredient(s), the techniques/methods, and equipment involved. Conventionally, each recipe is typically written as a stand-alone entity, although some cook books may reference a sub-component as another recipe found elsewhere in the cook book.

In contrast, in certain embodiments, the node-to-node system does not write a recipe based on only one method/technique using a specific piece of equipment or set of equipment. The node-to-node system of certain embodiments advantageously breaks this limitation and enables many variants of methods/techniques and/or equipment to be used based on the one base recipe. The node-to-node system of certain such embodiments are advantageously adaptive to the user by a much wider audience customized to their equipment or preferred techniques without altering the outcome of the recipe.

The node-to-node system of certain embodiments advantageously solves problems encountered by conventional systems by including standard node-to-node networks for each parent food (e.g., a Fresh Apple; White Pan Bread) and including all of the derivative forms and/or prepared/cooked forms of these standard node-to-node networks, enabling a chef to call out the exact form/preparation required to be used directly into the recipe.

For example: the recipe ingredients for Baked Cherry Pie can be: 1 lb. rolled pastry dough and 2 cups Cherry Filling, and the instructions for the recipe can be the assembly, baking and cooling of the cherry pie. In certain embodiments, the node-to-node system does not have to call out the making of the rolled pastry dough or how to make the cherry filling. Those procedures can be specified by separate nodes and separate recipes. If the node-to-node system is being used to present a specific recipe variant (e.g., having one or more variant ingredients, methods/techniques/equipment from that of a standard recipe) for the rolled pastry dough or the cherry filling, then the node-to-node system can advantageously generate the specific recipe variant using a standard node-to-node network and modifying it to reflect the variant element (e.g., a variant of the rolled pastry dough and/or a variant of the cherry filling). In this way, certain embodiments advantageously leverage the node-to-node system to be able to present alternative recipes (e.g., different from the standard recipes utilizing the standard node-to-node networks) to the user even though the alternative recipes have not been explicitly inputted to the system previously.

In certain embodiments, a recipe writer functionality of the node-to-node system is configured to create variants of a standard node-to-node network (e.g., the standard Rolled Pastry Dough network and/or the standard cherry filling network) in creating recipes to be presented to the user. Each variant can call out the form and/or state of the ingredients that are used directly into the recipe being made. The user can utilize the node-to-node system of certain embodiments to create their own variant node-to-node networks that differ from the standard or variant node-to-node networks in the node-to-node system.

In certain embodiments, the user can work backwards from the final recipe (e.g., End Node) to call out exactly how each and every ingredient(s) is to be made based on their own variants as needed. These can be stored in memory by the node-to-node system as the user's “standard” preferences and can be re-used as needed. For example, the recipe writer functionality of the node-to-node system may use the same rolled pastry dough in the apple pie, blueberry pie, raspberry pie, boysenberry pie, etc. recipes presented to the user, but the rolled pastry dough can reflect the particular user's desired variants to the standard recipe or node-to-node network for rolled pastry dough.

In certain embodiments, the recipe generated by the node-to-node system and presented to the user is configured based on the level of detail that the particular user needs. For example, an experienced chef may only need to glance at the ingredient list to know what to do. Whereas, a beginner may want to know how to prepare each and every ingredient, step by step. The node-to-node network of certain embodiments enables a beginner to get instruction from the beginning state of each ingredient or other relevant state as they require or desire. For example, if the beginner doesn't know how to chop onions, then the recipe can be expanded to start at a Fresh Onion and to take them step by step to having chopped onions. In certain embodiments in which the user also has their pantry items and quantity levels entered into the system, then the system configures the recipe based on the state of the ingredients in the user's pantry. For example, if a Fresh Onion exists in the user's pantry, then the system can configure the recipe to include the time, methods, and equipment to produce chopped onions. If chopped onions exist in the pantry, then the system can configure the recipe to include the existing chopped onions along with the time for gathering them.

In certain embodiments, the node-to-node system advantageously presents a virtual accordion for recipes to the user by which the user can expand out each ingredient and its preparation as needed. For example, if the user needs a step-by-step recipe for chopped onions, then the user can have this portion of the recipe unfold into the steps to chop an onion.

In certain embodiments, the node-to-node system is also configured to be used for kitchen management of the tools and equipment used for food preparation, handling, cooking, serving and clean up. The principal behind node-to-node kitchen management of certain such embodiments is “Everything has a Place and Every Place has a Thing.” Kitchen Management of tools and equipment can keep the tools and equipment in a proper condition for use with food. For example, bowls, pans, tools, serving plates, glasses, etc. are desired to be cleaned prior to being used to prepare, cook or serve food. Furthermore, the kitchen equipment is desired to be stored when not in use in its clean state. For example, kitchen equipment can be kept in their stored locations when not in use.

The folding of kitchen equipment is taking the tools and equipment, cleaning them properly and putting them in their proper place. If the items are clean and in their proper place, this is the “Folded” position. The user can designate the kitchen equipment on hand and can specify its proper storage area. To prepare, cook, and serve a meal requires that the tools and equipment are unfolded. They are gathered and placed in a proper place in order to be used for one or more recipes, and once the tools and equipment are used to prepare, cook and serve the meal, then they are in a soiled condition and may be left in many different locations. This is the unfolded position.

In certain embodiments, the node-to-node system advantageously tracks the equipment as it is used step-by-step and the quantities to be used in order to gather, prepare, cook, serve, bus, clean and place the equipment back into their “Folded” State. In certain embodiments, the node-to-node system is configured to scale recipes based on the number of individuals and their servings for a recipe and/or course and/or meal, and the kitchen management is tied to the recipes and their required equipment and/or substitutes. For example, if 5 people are attending a meal and soup is being served, the system can allocate 5 soup bowls and 5 soup spoons for that dish, and the recipe and its tools and equipment can be scaled for 5 people. For example, the stock pot volume can be scaled to match the volume of liquid needed for the soup for 5 people. If Champagne is going to be served for 5 adults for the first course of the meal, then the system allocates 5 champagne glasses, a champagne bucket with ice and kitchen towel. Courses of the meal are connected in the meal planning functionality of the node-to-node system, with the required plateware, silverware and glassware being related to their recipes for serving the meal.

In certain embodiments, the node-to-node system advantageously enables portions of the recipe networks to be assigned to one or more resources (e.g., users; chefs). Each discrete node-to-node segment corresponding to a task can be configured to be assignable to a resource, with each node-to-node segment comprising the time, temperature, pressure, speed, ingredients, equipment, and the method/technique providing a resource with all the relevant information to carry out the task. The system of certain embodiments stores in memory and can access from memory the sections of the node-to-node network (e.g., tasks) that any particular resource is capable of performing, advantageously enabling the system to delegate the tasks in order to optimize the recipes to be prepared and synchronized for the food to be prepared at a desired time. The system of certain embodiments can assign the resources to particular tasks, depending on the capabilities of the resources, to schedule the tasks and resources to work on different recipes to prepare the food for a desired time.

In certain embodiments, the node-to-node system is configured to work with a meal planner which specifies given recipes to be performed on a given day at a given time. The node-to-node system can be configured to coordinate the timing of tasks for one or more resources based on the task dependencies and the resource availability. The system furthermore can be configured to coordinate the tasks and the resources based on the resource's capabilities to prepare the food for a desired time. For example, kitchen tasks may include gathering food items, ingredients from the pantry, retrieving equipment for preparing and cooking the food, preparing the ingredients to the desired state, cooking the recipes, plating, serving, busing, cleaning, drying and putting back equipment in its proper place and storing left over food. Some of these tasks can be assigned by the node-to-node system to some resources (e.g., assigning retrieving, cleaning, and putting back equipment to household children and assigning cooking, plating, and serving to household adults).

In certain embodiments, the node-to-node system is configured to perform pantry management which can include the step-by-step processes which connect meal planning, pantry quantity levels, shopping lists, purchasing, obtaining from food vendors and storing the food in their relevant pantry locations. For example, the meals can be placed on a calendar on the day and time desired, and the node-to-node pantry management can allocate the pantry items to the meal calendar. A shopping list can be generated for items not available in the pantry. The shopping lists can all be connected via node-to-node segments from the vendor to the pantry. The time needed to obtain any given item from a vendor can be used to determine when the item(s) need to be purchased in order to arrive in time for the meal. Food items can have a particular shelf life which can be factored into when the food item is shipped and/or how frequently the food item is to be purchased so it is fresh. In some cases, there is not enough time to obtain the item from a particular vendor via shipping, so the shopping list may request that the item be delivered by a local market or picked up at a local market.

In certain embodiments, some or all of the recipes (e.g., homemade recipes; industrial recipes) of the node-to-node network can have full traceability (e.g., information provided to the user regarding the food at each step of the processing) through each of their standard or variant processing node-to-node steps, thereby providing the traceability and transparency which are desirable for a safe and effective food supply chain. The node-to-node segments can comprise the time, temperature, pressure and speed along with the method/technique, ingredients, and equipment used to process any part of the recipe. The node-to-node system can include the Farm to Table networks of foods and recipes. The traceability can include the step-by-step process and the passing of the ingredient/food's attributes and nutrition levels through the system whether it is homemade, farmstead, artisan, commercially or industrially produced. In certain embodiments, the node-to-node system advantageously supports the integration with third party sources of traceability, whether manual, automated, block-chain, rfid or other digital forms. The information can be passed through the node-to-node system to provide traceability of the ingredients. Traceability elements may include, origin, batch number, lot number, processing entities or personnel, transportation, storage, along with processing conditions or codes. This information can be utilized for both consumers and for the tracing back of potentially contaminated food for recall.

In certain embodiments, the food quality parameters are also fully traceable through the node-to-node network. For example, the Parent food may have various attributes, e.g., organic, GMO free, Extra Fancy Grade and be grown in Washington. These attributes can be passed through the node-to-node network and included in any recipe accessing the node-to-node network. For example, the attributes of the Red Delicious Fresh Apple in a user's pantry can be passed through the node-to-node network for apples to the final recipe made by the user. The nutrition and anti-nutrition of a given ingredient can also be passed through the node-to-node network and provided to the user by the node-to-node system. The system of certain embodiments can also make adjustments to the nutrition based on certain processing thresholds. For example, if a method/techniques is known to decrease water soluble vitamins at a given temperature, pressure or speed, then the reduction of those vitamins can be denoted by the node-to-node network accordingly. For another example, if soaking beans reduces their Lectin Levels (anti-nutrient), then the lectin level in the node-to-node network can be adjusted in the node-to-node section corresponding to the soaking of the beans. The capability of tracking food quality parameters can be extended out by the node-to-node network of certain embodiments to each of the products and/or vendors that make such products. For example, chickens may be butchered and then they may be either Air Chilled or Chilled in a Water Bath. The node-to-node network for chicken can track these types of processing differences. The user can then use the system to specify which attributes of their chicken they want (e.g., Organic Chicken that is Pasture Raised and Air Chilled).

The example matrix below shows some of the possible variations of the elements that make up a meal kit based on the node-to-node structure.

Matrix Possibilities for Source of Meal Elements

| | Ingredients | | Recipes | | Techniques | | Equipment | | Resources | |
|---|---|---|---|---|---|---|---|---|---|---|
| Entity | User | Chef | User | Chef | User | Chef | User | Chef | User | Chef |

Restaurant
Food Provider
Meal Kit
User
Chef
Dietician

The node-to-node structure of certain embodiments supports a multiplicity of entities specifying user, their own or third party ingredients, recipes, techniques, equipment and resources to perform the work. For example, at one end of the spectrum, a user could purchase a fully prepared meal from a restaurant. The meal and all its related elements are sourced, and cooked to the state that the user will consume it. At the other end of the spectrum, a user could source their own food, make it from scratch using their own resources, techniques, and equipment.

The node-to-node structure of certain embodiments advantageously enables tracking and providing the user with information (e.g., instructions) regarding a virtually unlimited variety of interactions. For example, a meal kit maker could use some of the ingredients supplied by the meal kit maker and ingredients contained in the user's pantry. The meal kit could be cooked by the user or a third party chef could be employed to prepare the meal. The third party chef could in turn use the user's kitchen equipment or bring some or all of their own.

In still more examples, a celebrity chef could recommend a series of recipes that are put on the user's meal calendar. These recipes may be endorsed by a particular dietician to be “Paleo” certified in alignment with their diet. The celebrity chef may endorse specific food products which are part of the recipes which the user purchases and maintains in their pantry. The chef may work with a meal kit company to provide meal kits for preparation by the user, but uses some of the food products contained in the user's pantry.

The recurring nature of the node-to-node structure of certain embodiments advantageously enables the meal kit company to set up and provide instructions for the proper techniques on how to make the meal. The meal kit company may use the node-to-node system of certain embodiments to assign certain products in the user's pantry, such as condiments like ketchup, mustard, etc. to compliment a given series of meal plans. The meal kit company may also have other ingredients (e.g., wild salmon) come directly from an endorsed food provider and the meal kit company can provide the rest of the ingredients or other elements of the meal in their meal kit. The node-to-node structure of certain embodiments facilitates an unprecedented marketplace for sourcing and configuring ingredients, food, recipe, methods/techniques, equipment by users, food providers, chefs, dieticians and recipe providers. These entities are able to use the node-to-node structure of certain embodiments to cross-pollinate their efforts into new, unprecedented and unending alliances. In certain embodiments, the user has unprecedented choice, selection, and value in whether to make, buy or make/buy combos for their food and dietary needs.

In certain embodiments, the node-to-node system comprises half States and half Actions, with each action leading to a new state. The node-to-node structure is organized in relation to actions, which are taken step by step to get to the goal of the end node—a meal, a dessert a completed recipe. The node-to-node system of certain embodiments advantageously enables various degrees of action to be taken. Some users may want all the actions taken for them and only enjoy the end node. Others want to interact with their ingredients and equipment or other chefs. The actions of the node-to-node structure in certain embodiments can form the basis of the experience that users have. The node-to-node system of certain embodiments can be a platform for taking action based on the user's level of preferences. The node-to-node system of certain embodiments comprises descriptions, videos, images at each of its nodes, which can contain standard descriptions, videos, images, but also can have variants contributed by the community at large. The node-to-node system of certain embodiments enables stories to be told by its community, helping people to learn the actions to take to learn about their food, its quality, its origin, its processing, its history and its nutrition. The node-to-node system of certain embodiments enables the kitchen of action, as the internet of action. The set of actions contained in the node-to-node system of certain embodiments forms an intelligence to help users learn, develop their skills, interact with their food, equipment and community.

Each chef learns rules of thumb of how to prepare, cook, serve and preserve food. These are generally ways, methods, techniques, etc. where from experience knowledge is gained. These rules of thumb are generally passed from one another through word of mouth or may sometimes be written down. The rules of thumb are generally passed around in small circles and some may be trade secrets of particular chefs. In certain embodiments, the node-to-node system enables the codification of rules of thumb to be incorporated into the methods, techniques, rules, guidelines or other appropriate knowledge (e.g., to help chefs from making common mistakes). Since the node-to-node network of certain embodiments is a recurring structure, these rules of thumb can be incorporated in given nodes, network segments or the methods/techniques between the nodes or between a series of nodes, planning courses, recipes or meals. For example, some categories of rules of thumb may include but are not limited to: Until Rules (e.g., cook until it solidifies), Timing Rules (e.g., after 2 minutes of simmering, turn down the heat), Incompatible Rules (e.g., don't mix cream and oil), Not Repeating Rules (e.g., don't have a cream soup in the same meal as a cream sauce), Substitution Rules (e.g., use 1 cup milk or use ½ cup evaporated milk mixed with ½ cup water).

In certain embodiments, the node-to-node system includes or is connectable to a meal planner, thereby enabling the node-to-node system to schedule recurring calendared meals, snacks, supplements, etc. on a recurring basis. The node-to-node system of certain embodiment is configured to be used to backward schedule from the time the item on the meal plan is needed with the minimum order quantity, shelf life, and planned future recurrence on the meal planner. In certain embodiments, the node-to-node system with a meal planner creates a recurring subscription system.

For example, users can schedule meal kits to have them on particular days throughout the year. The system can then coordinate the timing of the meal kits, provide their equipment and pantry pick lists, assign resources to prepare the required elements of the meal, allocate the dinnerware, silverware, glassware, etc. for serving the meal to the proper resource and synchronize these activities to be ready for the time on the meal calendar. The food in certain embodiments comes from the meal kit company, from other third party food providers, or is held on a recurring replenishment inventory in the user's pantry. The meal can be prepared by the household members or a third party chef could cook and serve the meal. In certain embodiments, the user schedules their supplements to be taken during the day and they are alerted to when each supplement and its quantity is scheduled to be taken. The meal planner can work in conjunction with the node-to-node system to schedule replenishment based on the container quantity, lead time and shelf life of the supplement(s) being taken. Food Items and/or meal kits can be placed on any number of recurrence cycles based either on the meal planner or on a min/max inventory system. Each item making up a recipe can be connected to its preparation techniques to prepare, cook, and serve the recipe and/or meal.

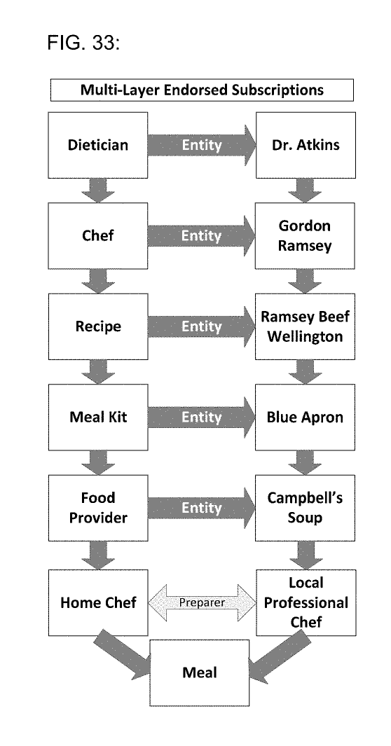

In certain embodiments, the node-to-node system enables a multi-layer endorsements for recipe subscriptions. FIG. 33 schematically illustrates some example multi-layer endorsed subscriptions in accordance with certain embodiments described herein. For example, dieticians may endorse certain chefs and/or their recipes that are compatible with their dietary advice. Chefs can put together recipes to constitute a given series of meal kits. The meal kits can endorse certain food product suppliers which provide ingredients for the meal kits. The meal kits can endorse certain local chefs which prepare, cook and/or serve the meal to the subscriber.

Dieticians, Chefs and Meal Kit Providers can endorse certain food products from particular food vendors. These endorsed food products can be the ingredients in the series of recipes that constitute a given series of meal kits over a subscription. The meal kits are not limited to coming in one package. In certain embodiments, the node-to-node system enables the meal kit to be expanded to include the subscriber's pantry. For example, the meal kit company may strategically assign meal kit ingredients in the user's pantry. This capability of the node-to-node system in certain embodiments opens up the very definition of a meal kit and enables virtually any one with recipes to create meal kits across the spectrum of food, equipment, chef resources, recipe types, etc.

More and more appliances are being connected to the internet. The appliances are becoming smart appliances with embedded computer chips, but also they are increasingly being connected to the internet. In certain embodiments, the node-to-node system enables these devices to be connected onto the node-to-node networks, with each node comprising the pressure, temperature, speed, time and the method/technique to employ step-by-step to make any and all recipes. The node-to-node system of certain embodiments has a multiplicity of equipment and paired equipment at each node, which can be the perfect platform for connecting and interacting with food and recipes for smart appliances. An appliance manufacturer can set up their own variants in the node-to-node system of certain embodiments to better optimize their particular appliance's operation. The user can select the preferences of the equipment for particular recipes. The node-to-node system of certain embodiments can then coordinate and synchronize the activities of the human, robot, and appliance/equipment resources to plan and carry out the tasks to prepare the recipes, and/or courses and or meals. The smart appliances can be scheduled along with the other resources based on the task dependencies and the resource dependencies to prepare, cook, and serve the meal for the desired time.

Certain embodiments described herein include methods which are performed by computer hardware, software or both, comprising one or more modules or engines (e.g., hardware or software programs that perform a specified function; can be used in operating systems, subsystems, application programs, or by other modules or engines). The hardware used for certain embodiments described herein can take a wide variety of forms, including processors, network servers, workstations, personal computers, mainframe computers and the like. The hardware running the software will typically include one or more input devices, such as a mouse, trackball, touchpad, and/or keyboard, a display, and computer-readable memory media, such as one or more random-access memory (RAM) integrated circuits and data storage devices (e.g., tangible storage, non-transitory storage, flash memory, hard-disk drive). It will be appreciated that one or more portions, or all of the software code may be remote from the user and, for example, resident on a network resource, such as a LAN server, Internet server, network storage device, etc.

The software code which configures the hardware to perform in accordance with certain embodiments described herein can be downloaded from a network server which is part of a local-area network or a wide-area network (such as the internet) or can be provided on a tangible (e.g., non-transitory) computer-readable medium, such as a CD-ROM or a flash drive. Various computer languages, architectures, and configurations can be used to practice the various embodiments described herein. For example, one or more modules or engines can be provided by one or more processors of one or more computers executing (e.g., running) computer code (e.g., one or more sets of instructions which are executable by the one or more processors of one or more computers). The computer code can be stored on at least one storage medium accessible by the one or more processors, as can other information (e.g., data) accessed and used by the one or more processors while executing the computer code.

Any process descriptions, elements, or blocks in the flow diagrams described herein and/or depicted in the attached figures should be understood as potentially representing modules, engines, segments, or portions of code which include one or more executable instructions for implementing specific logical functions or steps in the process. Alternate implementations are included within the scope of the embodiments described herein in which elements or functions may be deleted, executed out of order from that shown or discussed, including substantially concurrently or in reverse order, depending on the functionality involved, as would be understood by those skilled in the art. It will further be appreciated that the data and/or components described above may be stored on a computer-readable medium and loaded into memory of the computing device using a drive mechanism associated with a computer readable storing the computer executable components such as a CD-ROM, DVD-ROM, or network interface further, the component and/or data can be included in a single device or distributed in any manner. Accordingly, computing devices may be configured to implement the processes, algorithms and methodology of the present disclosure with the processing and/or execution of the various data and/or components described above.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Although commonly used terms are used to describe the systems and methods of certain embodiments for ease of understanding, these terms are used herein to have their broadest reasonable interpretation, as described in more detail herein. Although various aspects of the disclosure are described with regard to illustrative examples and embodiments, one skilled in the art will appreciate that the disclosed embodiments and examples should not be construed as limiting. It should be emphasized that many variations and modifications may be made to the above-described embodiments, the elements of which are to be understood as being among other acceptable examples. All such modifications and variations are intended to be included herein within the scope of this disclosure.

What is claimed is:

1. A method of providing food-related information, the method comprising:
receiving a user-generated food-related query;
generating, in response to the query, a subject identifier indicative of a food-related subject of the query;
accessing at least one computer database comprising a plurality of tables, each table of the plurality of tables having a food-related subject, each table of the plurality of tables comprising a top-level record corresponding to the subject of the table and a plurality of lower-level records that correspond to members of the subject of the table and that are hierarchically organized within the table, each lower-level record of the plurality of lower-level records comprising:
a first identifier indicative of the lower-level record;
at least one second identifier corresponding to the first identifier of another record in the table; and
a third identifier corresponding to the top-level record of the table; and
transmitting multiple tables of the plurality of tables to the user, the multiple tables comprising a primary table and at least one other table, the primary table comprising lower-level records having third identifiers that correspond to the subject identifier.

2. The method of claim 1, wherein the lower-level records of the primary table are connected to one another in a node-to-node structure.

3. The method of claim 2, wherein at least some of the lower-level records of the primary table are connected to at least some of the lower-level records of the at least one other table in the node-to-node structure.

4. The method of claim 1, wherein the food-related query comprises a text string and generating the subject identifier comprises:
accessing at least one alias table;
searching for a term of the at least one alias table that matches at least a portion of the text string;
obtaining the subject identifier that corresponds to the matched term of the at least one alias table; and
determining, based at least in part on the subject identifier, the primary table and the at least one other table to be transmitted to the user.

5. The method of claim 4, wherein the food-related query further comprises a realm identifier that identifies a realm of the food-related query, the realm selected from the group consisting of: food; equipment; preparation; recipe; and restaurant.

6. The method of claim 5, wherein accessing the at least one alias table comprises accessing one or more alias tables corresponding to the realm identified by the realm identifier.

7. The method of claim 4, wherein determining the at least one other table comprises accessing and using at least one template of a plurality of templates, the at least one template specifying a set of other tables which vary from the primary table in one or more attributes.

8. The method of claim 1, wherein the food-related subject of each table is selected from the group consisting of: a food class, a food preparation technique, and a food preparation tool.

9. The method of claim 1, wherein the members of the subject of the table comprise derivative forms of the subject.

10. The method of claim 9, wherein at least some tables of the plurality of tables each corresponds to a single food ingredient and each lower-level record of the table corresponds to a derivative form of the single food ingredient of the table.

11. The method of claim 1, wherein the at least one second identifier comprises at least one link to at least one other record in the table.

12. The method of claim 1, wherein the third identifier comprises a direct link to the top-level record of the table.

13. A computer system for providing food-related information, the system comprising:
at least one processor configured to provide food-related information to a plurality of user computing devices in response to food-related queries received from the plurality of user computing devices, the at least one processor configured to respond to a food-related query by generating a subject identifier indicative of a food-related subject of the query; and
at least one memory device in operative communication with the at least one processor, the at least one memory device operative to store at least one computer database comprising a plurality of tables, each table of the plurality of tables having a food-related subject, each table of the plurality of tables comprising a top-level record corresponding to the subject of the table and a plurality of lower-level records that correspond to members of the subject of the table and that are hierarchically organized within the table, each lower-level record of the plurality of lower-level records comprising:
a first identifier indicative of the lower-level record;
at least one second identifier corresponding to the first identifier of another record in the table; and
a third identifier corresponding to the top-level record of the table;
wherein the at least one processor is further configured to access the at least one computer database stored by the at least one memory device and to transmit multiple tables of the plurality of tables to the user, the multiple tables comprising a primary table and at least one other table, the primary table comprising lower-level records having third identifiers that correspond to the subject identifier.

14. The system of claim 13, wherein the at least one computer database are in a node-to-node structure.

15. The system of claim 13, wherein the third identifier comprises a direct link to the top-level record of the table.

16. The system of claim 13, wherein the query comprises a text string and the at least one processor is configured to generate the subject identifier by:
accessing at least one alias table;
searching for a term of the at least one alias table that matches at least a portion of the text string;
obtaining the subject identifier that corresponds to the matched term of the at least one alias table; and
determining, based at least in part on the subject identifier, the primary table and the at least one other table to be transmitted to the user.

17. The system of claim 13, wherein the at least one processor is configured to determine the at least one other table by accessing and using at least one template of a plurality of templates stored by the at least one memory device, the at least one template specifying a set of other tables which vary from the primary table in one or more attributes.

18. The system of claim 13, wherein the at least one processor is in operative communication with the plurality of user computing devices via the internet.

19. A non-transitory computer storage having stored thereon a computer program that instructs a computer system to provide food-related information by at least:
receiving a user-generated food-related query;
generating, in response to the query, a subject identifier indicative of a food-related subject of the query;
accessing at least one computer database comprising a plurality of tables, each table of the plurality of tables having a food-related subject, each table of the plurality of tables comprising a top-level record corresponding to the subject of the table and a plurality of lower-level records that correspond to members of the subject of the table and that are hierarchically organized within the table, each lower-level record of the plurality of lower-level records comprising:
a first identifier indicative of the lower-level record;
at least one second identifier corresponding to the first identifier of another record in the table; and
a third identifier corresponding to the top-level record of the table; and
transmitting multiple tables of the plurality of tables to the user, the multiple tables comprising a primary table and at least one other table, the primary table comprising lower-level records having third identifiers that correspond to the subject identifier.

20. The non-transitory computer storage of claim 19, wherein the query comprises a text string and the computer program instructs the computer system to further generate the subject identifier by:
accessing at least one alias table;
searching for a term of the at least one alias table that matches at least a portion of the text string;
obtaining the subject identifier that corresponds to the matched term of the at least one alias table; and
determining, based at least in part on the subject identifier, the primary table and the at least one other table to be transmitted to the user.
